(19) United States
(12) Patent Application Publication
(10) Pub. No.: US 2026/0313676 A1
(43) Pub. Date: Oct. 8, 2026

(54) ADAPTIVE RESOURCE UNIT (RU) ALLOCATION

(71) Applicant: Telefonaktiebolaget LM Ericsson (publ), Stockholm (SE)

(72) Inventors: Miguel LOPEZ, Aachen (DE); Leif WILHELMSSON, Lund (SE); Sebastian MAX, Cologne (DE); Charlie PETTERSSON, Solna (SE); Dennis SUNDMAN, Sollentuna (SE); Abhishek AMBEDE, Huddinge (SE)

(21) Appl. No.: 19/482,126

(22) PCT Filed: May 11, 2023
(86) PCT No.: PCT/EP2023/062679

§ 371 Date: Nov. 6, 2025

(51) Int. Cl. H04W 72/542

(52) U.S. Cl. CPC H04W 72/542

(57) ABSTRACT

A method, system and apparatus are disclosed. The method includes transmitting a first plurality of data units from a first station (STA) to a second STA according to a first resource configuration based on a first mapping of data units to resource units (RUs) of a corresponding transmission channel, where at least the first STA is configured with a full-duplex simultaneous transmission and reception (STR) configuration. The method includes receiving, during the first transmission, a feedback report from the second STA according to the STR configuration, detecting a link failure based on the feedback report, determining a second resource configuration for retransmitting at least one failed data unit to the second STA using a different resource configuration of the RUs of the corresponding transmission channel, and transmitting the at least one failed data unit to the second STA according to the different resource configuration.

### TECHNICAL FIELD

The present disclosure relates to wireless communications, and in particular, to adaptive resource unit (RU) allocation.

### BACKGROUND

Wi-Fi, also known as Wireless Local Area Network (WLAN), is a technology that currently mainly operates in the 2.4 GHZ, or the 5 GHz band, or the 6 GHz band. There are specifications regulating an access points' or wireless terminals' physical (PHY) layer, medium access layer (MAC) layer and other aspects in order to secure compatibility and inter-operability between different WLAN entities, e.g., between an access point and mobile terminals, both of which may be referred to as stations (STAs) herein. Wi-Fi is generally operated in license-exempt bands, and as such, communication over Wi-Fi may be subject to interference sources from any number of known and unknown devices. Wi-Fi is commonly used as wireless extensions to fixed broadband access, e.g., in domestic environments and hotspots, like airports, train stations and restaurants.

The IEEE 802.11 standard has initiated an Ultra High Reliability (UHR) study group whose objective is to develop a Project Authorization Request (PAR) and a Criteria for Standards Development (CSD) for a new 802.11 MAC/PHY amendment. The emphasis is on improvements to the WLAN to increase the reliability of wireless connectivity and to support lower latencies and deterministic latency, including dense deployments. Drivers for these requirements include extended reality applications (XR) and wireless control of industrial processes. In these applications the max allowed end-to-end latencies is often 5 ms or even as low as 1 ms, for example.

Multi-link Operation (MLO) and subband (non-overlapping) full duplex (SBFD) are technologies that enable access point (APs) and non-AP stations (non-AP STAs) to simultaneously receive and transmit data. In MLO, two STAs may communicate simultaneously over two or more radio channels, while in SBFD the bandwidth within one radio channel is split into non-overlapping subbands at the same STA, with one or more subbands allocated to transmission and the rest to reception.

In the IEEE 802.11ax PHY, the operating bandwidth may be divided into so-called resource units (RU). An RU is essentially a group of subcarriers. For example, an AP may allocate different RUs to different users to enable Orthogonal Frequency Division Multiple Access (OFDMA). The AP may also puncture one or more RUs if there is interference or external wireless equipment operating on those RUs (e.g., radars or incumbents), assuming, of course, that the AP is able to detect the interference. IEEE P802.11be extends the IEEE 802.11ax functionality by allowing one user to be allocated more than one RU, as well as puncturing the transmission to one user.

IEEE P802.11be supports channels up to 320 MHz wide, and it has been proposed for UHR to support up to 640 MHz in the 5 and 6 GHZ license-exempt bands. Measurements of interference indicate that the puncturing functionality may be useful, especially when the channel bandwidth exceeds 160 MHz, since the likelihood of interference may increase as the channel bandwidth increases.

### Dynamic ACK/NACK Notification Using Full Duplex Capability

In one example existing solution for feedback, ACK/NACK feedback is provided to the transmitting STA by exploiting the receiver STA address field in the MPDU header, such that if the address matches the address of the receiving STA, the receiving STA sends an ACK to the transmitting STA, assuming full duplex capability.

In some cases, WLAN may achieve very low latency when the traffic load is low and there is no interference, or more generally, when the channel conditions are conducive to low latency. However, when the radio channels are very wide, the probability of interference or channel degradation increases. The sources of interference may include, e.g., machinery, radars, fixed wireless access links, other WLANs, etc., many of which cannot be controlled.

Thus, existing systems lack support for adaptive RU allocation in a wireless communication system.

### SUMMARY

Because a first STA (e.g., an AP or non-AP STA) that is communicating with the a second STA (e.g., an AP or non-AP STA) may experience very different interference conditions than the second STA, it may be the case that the second STA ideally should have punctured (e.g., left blank, unused, dropped, etc.) one or more RUs if the second STA had been aware of the interference conditions at the first STA, but only based on knowledge of the interference situation at the second STA, the second STA may instead (incorrectly) determine the RU to be suitable to use. Moreover, due to the coarse granularity in the modulation and coding schemes, and even in the absence of interference, there are instances where the link adaptation may be improved by puncturing a part of the bandwidth where the channel is poor and the SNR is too low, and instead increasing the data rate in the non-punctured part of the channel.

Embodiments of the present disclosure provide configurations for supporting a protocol for transmission of critical data with low latency. For example, in at least some embodiments, at least one of the STAs involved in the data transmission is assumed to support simultaneous transmission and reception (STR). The bandwidth over which the critical data is transmitted may be divided into several RUs. The receiving STA monitors the integrity of data units of the received physical data packets. In some embodiments, the data units may be relatively small. For example, the receiver may monitor individual LDPC codewords. When an error is detected in one data unit, the receiver attempts to detect whether the bit errors are concentrated in some RUs (e.g., when there is interference present in some of the RUs), and it transmits a feedback report to the other STA, which is assumed to support STR. If the receiving STA also supports STR, the receiving STA may continue receiving while transmitting the feedback, whereas if it does not support STR, it will stop receiving while transmitting the feedback report. The report may include a NACK for the data units received in error and the RUs over which an excess in transmission errors were detected (e.g., the number of transmission errors exceeds some predefined threshold). Upon reception of the report, the transmitting STA may puncture the RUs exhibiting poor quality and retransmits at least some portions of the erroneously received data units over the non-punctured portion of the bandwidth.

For example, some embodiments may support configurations for a method to determine the RU allocations for transmission and reception between 2 STAs (labeled STA1 and STA2, where STA1 sends critical data to STA2) and where at least STAI supports (i.e., is capable of) simultaneous TX and RX, including one or more of:
Selecting a first RU allocation, with some RUs allocated to (critical) data and other(s) to feedback reports;
Transmitting data in the allocated RUs (performed by STA1);
Determining whether a data unit (i.e., a codeword) in the received packet was received in error (e.g. using a parity check or a CRC) (performed by STA2);
Determining whether there are RUs over which the channel quality is poor (performed by STA2);
Transmitting a feedback report comprising a NACK for the data units in error and indicating the RUs with poor channel conditions (performed by STA2);
The NACK may be implicit;
Interrupting the data transmission at least in the interfered RUs (performed by STA1);
Selecting a second RU allocation based on the received feedback report (performed by STA1);
Indicating the updated RU allocation to the STA receiving the data (performed by STA1); and/or
Retransmitting the data received in error on the selected RUs (performed by STA1).

In some embodiments, when STA2 is also STR capable, then STA2 may be configured to transmit the feedback report while continuing with (e.g., without interrupting) the critical data reception.

Some embodiments may therefore enable very low latency retransmissions (e.g., less than 1 ms to 5 ms may be attainable in practice, for some embodiments) when the data is corrupted due to the presence of interference or when the link adaptation fails.

According to a first aspect of the present disclosure, a method implemented in a first station (STA) (e.g., a transmitting STA1) configured to wirelessly communicate with a second STA (e.g., a receiving STA2) in a wireless communication system is provided. The first STA1 may be an STR-capable device and/or full-duplex-capable device which is configured (e.g., preconfigured, configured by another node, etc.) with a full-duplex STR configuration. The method includes transmitting a first transmission of a first plurality of data units to the second STA2 according to a first resource configuration, where the first resource configuration includes a first mapping of the first plurality of data units to a first plurality of resource units (RUs) of a corresponding transmission channel, receiving, during the first transmission, at least one first feedback report from the second STA2, where the at least one first feedback report includes feedback information for a receiver of the second STA2 and is associated with the first transmission, the at least one first feedback report is received by the first STA1 using the full-duplex STR configuration, and the full-duplex STR configuration allocates radio resources for a feedback report from the second STA2 to be transmitted concurrently with a data transmission from the first STA1, detecting a link failure associated with at least one failed data unit of the first plurality of data units based on the at least one first feedback report, determining a second resource configuration for retransmitting the at least one failed data unit to the second STA2, where the second resource configuration includes a second mapping of the at least one failed data unit to a second plurality of RUs of the corresponding transmission channel, and transmitting a second transmission of the at least one failed data unit to the second STA2 according to the second resource configuration.

In one or more embodiments, the first STAI is one of an access point (AP) and a non-AP STA, and the second STA2 is one of an AP and a non-AP STA.

In one or more embodiments, the method further includes receiving the at least one first feedback report (e.g., a first feedback report, at least one of a plurality of feedback reports, etc., associated with the data transmission from STA1 to STA2) from the second STA2 during the first transmission when the second STA2 is at least one of an STR-capable device and a full-duplex-capable device which is capable of transmitting the at least one first feedback report while continuing to receive the first transmission from the first STA1.

In one or more embodiments, the first STAI is further configured to interrupt the first transmission based on the detection of the link failure.

In one or more embodiments, the full-duplex STR configuration corresponds to one or more of a frequency division duplexing (FDD) configuration, an in-band full-duplex (IBFD) configuration, and a subband full duplex (SBFD) configuration.

According to one or more embodiments of this aspect, the at least one first feedback report includes at least one of a bitmap indicating acknowledgment information for at least a subset of the first plurality of data units, interference information associated with at least one RU of the first plurality of RUs, measurement information associated with at least one RU of the first plurality of RUs, an indication of a failure to decode the at least one failed data unit, and an indication of a successful reception of at least one successful data unit of the first plurality of data units.

According to one or more embodiments of this aspect, the detecting of the reception failure includes detecting a failure to receive at least one expected feedback report from the second STA2 for at least one of the first plurality of data units. According to one or more embodiments of this aspect, the determining of the second resource configuration includes puncturing a first RU of the first plurality of RUs based on the link failure being associated with at least one failed data unit transmitted on at least the first RU. According to one or more embodiments of this aspect, the second transmission further includes a second plurality of data units, where the second plurality of data units is transmitted according to the second resource configuration, and the second mapping of the second resource configuration further maps the second plurality of data units to the second plurality of RUs. According to one or more embodiments of this aspect, the method further includes at least one of transmitting, to the second STA2, a first indication of the first resource configuration, transmitting, to the second STA2, a second indication of the second resource configuration, and transmitting, to the second STA2, a third indication of the full-duplex STR configuration.

According to one or more embodiments of this aspect, the second indication further indicates at least one of a time until switching from the first resource configuration to the second resource configuration, a Short Interframe Space (SIFS) time between consecutive feedback reports, and (an indication of) whether each data unit of the second transmission is contained within a single RU. According to one or more embodiments of this aspect, the method further includes transmitting, to the second STA2 and at least one additional STA, a feedback reporting configuration, the feedback reporting configuration configuring the second STA2 and the at least one additional STA to avoid collisions in feedback reporting to the first STA1. According to one or more embodiments of this aspect, each of the first plurality of data units is associated with a corresponding feedback report of a first plurality of feedback reports expected from the second STA2, and the method further includes attempting to receive each of the first plurality of feedback reports subsequent to transmission of the corresponding data unit of the first plurality of data units, each attempted reception of the first plurality of feedback reports being optionally separated by a Short Interframe Space (SIFS) time. According to one or more embodiments of this aspect, the method further includes detecting a missing feedback report of the first plurality of feedback reports, where the missing feedback report is associated with at least one first RU of the first plurality of RUs, and responsive to detecting the missing feedback report, transmitting the second resource configuration to the second STA2, where the second resource configuration includes a puncturing of the at least one first RU. According to one or more embodiments of this aspect, the at least one first feedback report is received from the second STA2 on a control RU which is separate from the first plurality of RUs. According to one or more embodiments of this aspect, the method further includes transmitting of a trigger indication to the second STA2 using the control RU, and receiving the at least one first feedback report (e.g., a first feedback report, at least one of a plurality of feedback reports, etc., associated with the data transmission from STA1 to STA2) in response to the trigger indication. According to one or more embodiments of this aspect, the first plurality of RUs include at least one first RU and at least one second RU, the link failure being associated with interference in the at least one first RU, and the second plurality of RUs excluding the at least one first RU.

According to one or more embodiments of this aspect, the second resource configuration modifies at least one of a timing configuration of the first resource configuration, a bandwidth of the first resource configuration, a puncturing configuration of the first resource configuration, a modulation coding scheme (MCS) of the first resource configuration, and an ordering of transmission of the first plurality of data units of the first resource configuration.

According to one or more embodiments of this aspect, the first mapping includes one of each data unit of the first plurality of data units being mapped to a corresponding single RU of the first plurality of RUs, and each data unit of the first plurality of data units being mapped to multiple RUs of the first plurality of RUs. According to one or more embodiments of this aspect, the method further includes receiving a second feedback report from the second STA2, and reverting to the first resource configuration based on the second feedback report.

According to one or more embodiments of this aspect, the first plurality of data units correspond to a first plurality of codewords of a physical layer protocol data unit (PPDU).

According to another aspect of the present disclosure, a first station (STA) (e.g., a transmitting STA1) configured to wirelessly communicate with a second STA2 (e.g., a receiving STA2) in a wireless communication system is provided. The first STA1 (and/or the second STA2) may be an STR-capable device (and/or full-duplex-capable device) which is configured (e.g., preconfigured, configured by another node, etc.) with a full-duplex STR configuration. The first STA1 is configured to transmit a first transmission of a first plurality of data units to the second STA2 according to a first resource configuration, where the first resource configuration includes a first mapping of the first plurality of data units to a first plurality of resource units (RUs) of a corresponding transmission channel, receive, during the first transmission, at least one first feedback report from the second STA2 for the first transmission, where the at least one first feedback report includes feedback information for a receiver of the second STA2 and is associated with the first transmission, the at least one first feedback report is received by the first STA1 using the full-duplex STR configuration, and the full-duplex STR configuration allocates radio resources for a feedback report from the second STA2 to be transmitted concurrently with a data transmission from the first STA1, detect a link failure associated with at least one failed data unit of the first plurality of data units based on the at least one first feedback report, determine a second resource configuration for retransmitting the at least one failed data unit to the second STA2, where the second resource configuration includes a second mapping of the at least one failed data unit to a second plurality of RUs of the corresponding transmission channel, and transmit a second transmission of the at least one failed data unit to the second STA2 according to the second resource configuration.

In one or more embodiments, the first STA1 is one of an access point (AP) and a non-AP STA, and the second STA2 is one of an AP and a non-AP STA.

In one or more embodiments, the first STA1 is further configured to receive the at least one first feedback report from the second STA2 during the first transmission when the second STA2 is at least one of an STR-capable device and a full-duplex-capable device which is capable of transmitting the at least one first feedback report (e.g., a first feedback report, at least one of a plurality of feedback reports, etc., associated with the data transmission from STA1 to STA2) while continuing to receive the first transmission from the first STA1.

In one or more embodiments, the first STA1 is further configured to interrupt the first transmission based on the detection of the link failure.

In one or more embodiments, the full-duplex STR configuration corresponds to one or more of a frequency division duplexing (FDD) configuration, an in-band full-duplex (IBFD) configuration, and a subband full duplex (SBFD) configuration.

According to one or more embodiments of this aspect, the at least one first feedback report includes at least one of a bitmap indicating acknowledgment information for at least a subset of the first plurality of data units, interference information associated with at least one RU of the first plurality of RUs, measurement information associated with at least one RU of the first plurality of RUs, an indication of a failure to decode the at least one failed data unit, and an indication of a successful reception of at least one successful data unit of the first plurality of data units.

According to one or more embodiments of this aspect, the detecting of the reception failure includes detecting a failure to receive at least one expected feedback report from the second STA2 for at least one of the first plurality of data units. According to one or more embodiments of this aspect, the determining of the second resource configuration includes puncturing a first RU of the first plurality of RUs based on the link failure being associated with at least one failed data unit transmitted on at least the first RU. According to one or more embodiments of this aspect, the second transmission further includes a second plurality of data units, where the second plurality of data units is transmitted according to the second resource configuration, and the second mapping of the second resource configuration further maps the second plurality of data units to the second plurality of RUs. According to one or more embodiments of this aspect, the first STA1 is further configured to at least one of transmit, to the second STA2, a first indication of the first resource configuration, transmit, to the second STA2, a second indication of the second resource configuration, and transmit, to the second STA2, a third indication of the full-duplex STR configuration.

According to one or more embodiments of this aspect, the second indication further indicates at least one of a time until switching from the first resource configuration to the second resource configuration, a Short Interframe Space (SIFS) time between consecutive feedback reports, and (an indication of) whether each data unit of the second transmission is contained within a single RU. According to one or more embodiments of this aspect, the first STAI is further configured to transmit, to the second STA2 and at least one additional STA, a feedback reporting configuration, the feedback reporting configuration configuring the second STA2 and the at least one additional STA to avoid collisions in feedback reporting to the first STA1. According to one or more embodiments of this aspect, each of the first plurality of data units is associated with a corresponding feedback report of a first plurality of feedback reports expected from the second STA2, and the first STA1 is further configured to attempt to receive each of the first plurality of feedback reports subsequent to transmission of the corresponding data unit of the first plurality of data units, each attempted reception of the first plurality of feedback reports being optionally separated by a Short Interframe Space (SIFS) time.

According to one or more embodiments of this aspect, the first STA1 is further configured to detect a missing feedback report of the first plurality of feedback reports, where the missing feedback report is associated with at least one first RU of the first plurality of RUs, and responsive to detecting the missing feedback report, transmit the second resource configuration to the second STA2, where the second resource configuration includes a puncturing of the at least one first RU. According to one or more embodiments of this aspect, the at least one first feedback report is received from the second STA2 on a control RU which is separate from the first plurality of RUs. According to one or more embodiments of this aspect, the first STA1 is further configured to transmit a trigger indication to the second STA2 using the control RU, and receive the at least one feedback report in response to the trigger indication. According to one or more embodiments of this aspect, the first plurality of RUs include at least one first RU and at least one second RU, the link failure being associated with interference in the at least one first RU, and the second plurality of RUs excluding the at least one first RU.

According to one or more embodiments of this aspect, the second resource configuration modifies at least one of a timing configuration of the first resource configuration, a bandwidth of the first resource configuration, a puncturing configuration of the first resource configuration, a modulation coding scheme (MCS) of the first resource configuration, and an ordering of transmission of the first plurality of data units of the first resource configuration.

According to one or more embodiments of this aspect, the first mapping includes one of each data unit of the first plurality of data units being mapped to a corresponding single RU of the first plurality of RUs, and each data unit of the first plurality of data units being mapped to multiple RUs of the first plurality of RUs. According to one or more embodiments of this aspect, the first STA1 is further configured to receive a second feedback report from the second STA2, and revert to the first resource configuration based on the second feedback report.

According to one or more embodiments of this aspect, the first plurality of data units correspond to a first plurality of codewords of a physical layer protocol data unit (PPDU).

According to another aspect of the present disclosure, a method implemented in a first station (STA) (e.g., a receiving STA2) configured to wirelessly communicate with a second STA (e.g., a transmitting STA1) in a wireless communication system is provided, where the first STA2 (and/or the second STA1) may be configured with a full-duplex simultaneous transmission and reception (STR) configuration. The method includes receiving a first transmission of a first plurality of data units from the second STA1 according to a first resource configuration, the first resource configuration including a first mapping of the first plurality of data units to a first plurality of resource units (RUs) of a corresponding transmission channel, detecting a link failure for at least one failed data unit of the first plurality of data units, transmitting, to the second STA1, at least one first feedback report based on the link failure, where the at least one first feedback report includes feedback information for a receiver of the second STA1 and is associated with the first transmission, the at least one first feedback report is transmitted by the first STA2 using the full-duplex STR configuration, and the full-duplex STR configuration allocates radio resources for a feedback report from the first STA2 to be transmitted concurrently with a data transmission from the second STA1, and responsive to transmitting the at least one first feedback report, receiving a second transmission, from the second STA1, of the at least one failed data unit according to a second resource configuration, where the second resource configuration includes a second mapping of the at least one failed data unit to a second plurality of RUs of the corresponding transmission channel.

In one or more embodiments, the first STA2 is one of an access point (AP) and a non-AP STA, and the second STA1 is one of an AP and a non-AP STA.

In one or more embodiments, the method further includes transmitting the at least one first feedback report (e.g., a first feedback report, at least one of a plurality of feedback reports, etc., associated with the data transmission from STA1 to STA2) from the first STA2 to the second STA1 without interrupting the receiving of the first transmission when the first STA2 is an STR-capable device and/or a full-duplex-capable device.

In one or more embodiments, the full-duplex STR configuration corresponds to one or more of a frequency division duplexing (FDD) configuration, an in-band full-duplex (IBFD) configuration, and a subband full duplex (SBFD) configuration.

According to one or more embodiments of the present disclosure, the at least one first feedback report includes at least one of a bitmap indicating acknowledgment information for at least a subset of the first plurality of data units, interference information associated with at least one RU of the first plurality of RUs, measurement information associated with at least one RU of the first plurality of RUs, an indication of a failure to decode the at least one failed data unit, and an indication of a successful reception of at least one successful data unit of the first plurality of data units.

According to one or more embodiments, the second resource configuration includes a puncturing of a first RU of the first plurality of RUs based on at least one failed data unit being mapped to at least the first RU according to the first mapping. According to one or more embodiments, the second transmission further includes a second plurality of data units, the second plurality of data units being received according to the second resource configuration, the second mapping of the second resource configuration further mapping the second plurality of data units to the second plurality of RUs.

According to one or more embodiments, the method further includes at least one of receiving, from the second STA1, a first indication of the first resource configuration, receiving, from the second STA1, a second indication of the second resource configuration, and receiving, from the second STA1, a third indication of the full-duplex STR configuration. According to one or more embodiments, the second indication further indicates at least one of a time until switching from the first resource configuration to the second resource configuration, a Short Interframe Space (SIFS) time between consecutive feedback reports, and whether each data unit of the second transmission is contained within a single RU.

According to one or more embodiments, the method further includes receiving, from the second STA1, a feedback reporting configuration, the feedback reporting configuration configuring the second STA1 and at least one additional STA to avoid collisions in feedback reporting to the first STA2.

According to one or more embodiments, each of the first plurality of data units is associated with a corresponding feedback report of a first plurality of feedback reports to be transmitted from the first STA2, and the method further includes transmitting each of the first plurality of feedback reports to the second STA1, each transmission of each corresponding feedback report being optionally separated by a Short Interframe Space (SIFS) time.

According to one or more embodiments, the at least one first feedback report is transmitted to the second STA1 on a control RU which is separate from the first plurality of RUs. According to one or more embodiments, the first STA2 is a simultaneous transmission and reception (STR) device, and the method further comprising transmitting the at least one first feedback report (e.g., a first feedback report, at least one of a plurality of feedback reports, etc., associated with the data transmission from STA1 to STA2) while continuing to receive the first transmission from the second STA1.

According to one or more embodiments, the method further includes receiving a trigger indication from the second STA1 on the control RU, and transmitting at least one first feedback report to the second STA1 in response to the trigger indication.

According to one or more embodiments, the first plurality of RUs include at least one first RU and at least one second RU, the link failure being associated with interference in the at least one first RU, and the second plurality of RUs excluding the at least one first RU.

According to one or more embodiments, the second resource configuration modifies at least one of a timing configuration of the first resource configuration, a bandwidth of the first resource configuration, a puncturing configuration of the first resource configuration, a modulation coding scheme (MCS) of the first resource configuration, and an ordering of transmission of the first plurality of data units of the first resource configuration.

According to one or more embodiments, the first mapping includes one of each data unit of the first plurality of data units being mapped to a corresponding single RU of the first plurality of RUs, and each data unit of the first plurality of data units being mapped to multiple RUs of the first plurality of RUS.

According to one or more embodiments, the method further includes transmitting a second feedback report to the second STA1, and reverting to the first resource configuration based on the second feedback report. According to one or more embodiments, the first plurality of data units correspond to a first plurality of codewords of a physical layer protocol data unit (PPDU).

According to another aspect of the present disclosure, a first station (STA) (e.g., a receiving STA2) configured to wirelessly communicate with a second STA (e.g., a transmitting STA1) in a wireless communication system is provided, where the second STA1 (and/or the first STA2) may be configured with a full-duplex simultaneous transmission and reception (STR) configuration. The first STA2 is configured to receive a first transmission of a first plurality of data units from the second STA1 according to a first resource configuration, the first resource configuration including a first mapping of the first plurality of data units to a first plurality of resource units (RUs) of a corresponding transmission channel, detect a link failure for at least one failed data unit of the first plurality of data units, transmit, to the second STA1, at least one first feedback report based on the link failure, where the at least one first feedback report includes feedback information for a receiver of the second STA1 and is associated with the first transmission, the at least one first feedback report is transmitted by the first STA2 using the full-duplex STR configuration, and the full-duplex STR configuration allocates radio resources for a feedback report from the first STA2 to be transmitted concurrently with a data transmission from the second STA1, and responsive to transmitting the at least one first feedback report, receive a second transmission, from the second STA1, of the at least one failed data unit according to a second resource configuration, where the second resource configuration includes a second mapping of the at least one failed data unit to a second plurality of RUs of the corresponding transmission channel.

In one or more embodiments, the first STA2 is one of an access point (AP) and a non-AP STA, and the second STAI is one of an AP and a non-AP STA.

In one or more embodiments, the first STA2 is further configured to transmit the at least one first feedback report from the first STA2 to the second STA1 without interrupting the receiving of the first transmission when the first STA2 is an STR-capable device and/or a full-duplex capable device.

In one or more embodiments, the full-duplex STR configuration corresponds to one or more of a frequency division duplexing (FDD) configuration, an in-band full-duplex (IBFD) configuration, and a subband full duplex (SBFD) configuration.

According to one or more embodiments of the present disclosure, the at least one first feedback report includes at least one of a bitmap indicating acknowledgment information for at least a subset of the first plurality of data units, interference information associated with at least one RU of the first plurality of RUs, measurement information associated with at least one RU of the first plurality of RUs, an indication of a failure to decode the at least one failed data unit, and an indication of a successful reception of at least one successful data unit of the first plurality of data units.

According to one or more embodiments, the second resource configuration includes a puncturing of a first RU of the first plurality of RUs based on at least one failed data unit being mapped to at least the first RU according to the first mapping. According to one or more embodiments, the second transmission further includes a second plurality of data units, the second plurality of data units being received according to the second resource configuration, the second mapping of the second resource configuration further mapping the second plurality of data units to the second plurality of RUs.

According to one or more embodiments, the first STA2 is further configured to at least one of receive, from the second STA1, a first indication of the first resource configuration, receive, from the second STA1, a second indication of the second resource configuration, and receive, from the second STA1, a third indication of the full-duplex STR configuration. According to one or more embodiments, the second indication further indicates at least one of a time until switching from the first resource configuration to the second resource configuration, a Short Interframe Space (SIFS) time between consecutive feedback reports, and whether each data unit of the second transmission is contained within a single RU.

According to one or more embodiments, the first STA2 is further configured to receive, from the second STA1, a feedback reporting configuration, the feedback reporting configuration configuring the second STA1 and at least one additional STA to avoid collisions in feedback reporting to the first STA2.

According to one or more embodiments, each of the first plurality of data units is associated with a corresponding feedback report of a first plurality of feedback reports to be transmitted from the first STA2, and the first STA2 is further configured to transmit each of the first plurality of feedback reports to the second STA1, each transmission of each corresponding feedback report being optionally separated by a Short Interframe Space (SIFS) time.

According to one or more embodiments, the at least one first feedback report is transmitted to the second STA1 on a control RU which is separate from the first plurality of RUs. According to one or more embodiments, the first STA2 is a simultaneous transmission and reception (STR) device, and the first STA2 is further configured to transmit the at least one first feedback report while continuing to receive the first transmission from the second STA1.

According to one or more embodiments, the first STA2 is further configured to receive a trigger indication from the second STA1 on the control RU, and transmit at least one first feedback report to the second STA1 in response to the trigger indication. According to one or more embodiments, the first plurality of RUs include at least one first RU and at least one second RU, the link failure is associated with interference in the at least one first RU, and the second plurality of RUs excludes the at least one first RU.

According to one or more embodiments, the second resource configuration modifies at least one of a timing configuration of the first resource configuration, a bandwidth of the first resource configuration, a puncturing configuration of the first resource configuration, a modulation coding scheme (MCS) of the first resource configuration, and an ordering of transmission of the first plurality of data units of the first resource configuration.

According to one or more embodiments, the first mapping includes one of each data unit of the first plurality of data units being mapped to a corresponding single RU of the first plurality of RUs, and each data unit of the first plurality of data units being mapped to multiple RUs of the first plurality of RUS.

According to one or more embodiments, the first STA2 is further configured to transmit a second feedback report to the second STA1, and revert to the first resource configuration based on the second feedback report. According to one or more embodiments, the first plurality of data units correspond to a first plurality of codewords of a physical layer protocol data unit (PPDU).

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a block diagram of a STA1 communicating with a STA2 over an at least partially wireless connection according to some embodiments of the present disclosure;

FIG. 2 is a schematic diagram of an example network architecture illustrating a communication system connected via an intermediate network to a host computer according to the principles in the present disclosure;

FIG. 3 is a block diagram of a host computer communicating via a STA1 with a STA2 over an at least partially wireless connection according to some embodiments of the present disclosure;

FIG. 4 is a flowchart illustrating example methods implemented in a communication system including a host computer, a STA1 and a STA2 for executing a client application at a STA2 according to some embodiments of the present disclosure;

FIG. 5 is a flowchart illustrating example methods implemented in a communication system including a host computer, a STA1 and a STA2 for receiving user data at a STA2 according to some embodiments of the present disclosure;

FIG. 6 is a flowchart illustrating example methods implemented in a communication system including a host computer, a STA1 and a STA2 for receiving user data from the STA2 at a host computer according to some embodiments of the present disclosure;

FIG. 7 is a flowchart illustrating example methods implemented in a communication system including a host computer, a STA1 and a STA2 for receiving user data at a host computer according to some embodiments of the present disclosure;

FIG. 8 is a flowchart of an example process in a STA1 for supporting configurations for adaptive RU allocation, according to some embodiments of the present disclosure;

FIG. 9 is a flowchart of an example process in a STA2 for supporting configurations for adaptive RU allocation, according to some embodiments of the present disclosure;

FIG. 10 is a signal timing diagram illustrating an example configuration according to some embodiments of the present disclosure;

FIG. 11 is a signal timing diagram illustrating another example configuration according to some embodiments of the present disclosure; and

FIG. 12 is a signal timing diagram illustrating another example configuration according to some embodiments of the present disclosure.

### DETAILED DESCRIPTION

Before describing in detail example embodiments, it is noted that the embodiments reside primarily in combinations of apparatus components and processing steps related to adaptive RU allocation. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, the term “access point” or “AP” is used interchangeably and may comprise, or be, a network node. The AP may include any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB), donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The AP may also comprise test equipment. The AP may comprise a radio router, a radio transceiver, WiFi access point, wireless local area network (WLAN) access point, a network controller, etc.

In some embodiments, the non-limiting term “device” is used to describe a wireless device (WD) and/or user equipment (UE) that may be used to implement some embodiments of the present disclosure. In some embodiments, the device may be and/or comprise an access point (AP) station (STA). In some embodiments, the device may be and/or comprise a non-access point station (non-AP STA). In some embodiments, the device may be any type of device capable of communicating with a network node, such as an AP, over radio signals. The device may be any radio communication device, target device, a portable device, device-to-device (D2D) device, machine type device or device capable of machine to machine communication (M2M), low-cost and/or low-complexity device, a sensor equipped with a device, a computer, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, Reduced Capability (RedCap) device, etc.

A device may be considered a network node and may include physical components, such as processors, allocated processing elements, or other computing hardware, computer memory, communication interfaces, and other supporting computing hardware. The network node may use dedicated physical components, or the node may be allocated use of the physical components of another device, such as a computing device or resources of a datacenter, in which case the network node is said to be virtualized. A network node may be associated with multiple physical components that may be located either in one location, or may be distributed across multiple locations.

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter (e.g., STA1) and a receiver (e.g., STA2). For DL communication, a STA1 may be the transmitter and the receiver is the STA2. For the UL communication, the transmitter may be the STA2 and the receiver is the STA1. In some embodiments, the STA1 may be an AP or non-AP STA, and the STA2 may be an AP or a non-AP STA. The terms “STA1”, STA2”, STA3”, etc., as used herein are not intended to be limiting, but are merely intended refer to one or more of various types of stations and/or devices (e.g., APs, non-AP STAs, user equipment, wireless devices, mobile terminals, etc.).

Note also that some embodiments of the present disclosure may be supported by an Institute of Electrical Engineers (IEEE) 802.11 standard. IEEE 802.11 denotes a set of Wireless Local Area Network (WLAN) air interface standards developed by the IEEE 802.11 committee for short-range communications (e.g., tens of meters to a few hundred meters). Some embodiments may also be supported by standard documents disclosed in Third Generation Partnership Project (3GPP) technical specifications. That is, some embodiments of the description can be supported by the above documents. In addition, all the terms disclosed in the present document may be described by the above standard documents.

Note that although terminology from one particular wireless system, such as, for example, IEEE 802.11, 3rd Generation Partnership Project (3GPP), Long Term Evolution (LTE), 5th Generation (5G) and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by one or more of a first STA, second STA, transmitting STA, receiving STA, AP, non-AP STA, wireless device, network node, etc., may be distributed over a plurality of STAs, APs, non-AP STAs, wireless devices, network nodes, etc. In other words, it is contemplated that the functions of the devices described herein are not limited to performance by a single physical device and, in fact, can be distributed among several physical devices.

As used herein, the terms “puncturing,” “preemption,” “overriding”, and “pre-emption” (as in “punctured channels,” “puncturing of RUs,” etc.) may be used interchangeably. For example, puncturing may refer to a situation where STA may assume that no transmission to the STA is present in a part of the bandwidth. As another example, some of the DL resources are nominally allocated to DL data (or UL data), but have been ‘punctured’ by, i.e., replaced with, e.g., control information, other data information, etc., that is not associated with the DL data (or UL data), which may occur in a puncturing region. Puncturing may mean, e.g., that the bits (and/or symbols, etc.) in the affected resource units are replaced with “new” information.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for supporting adaptive RU allocation.

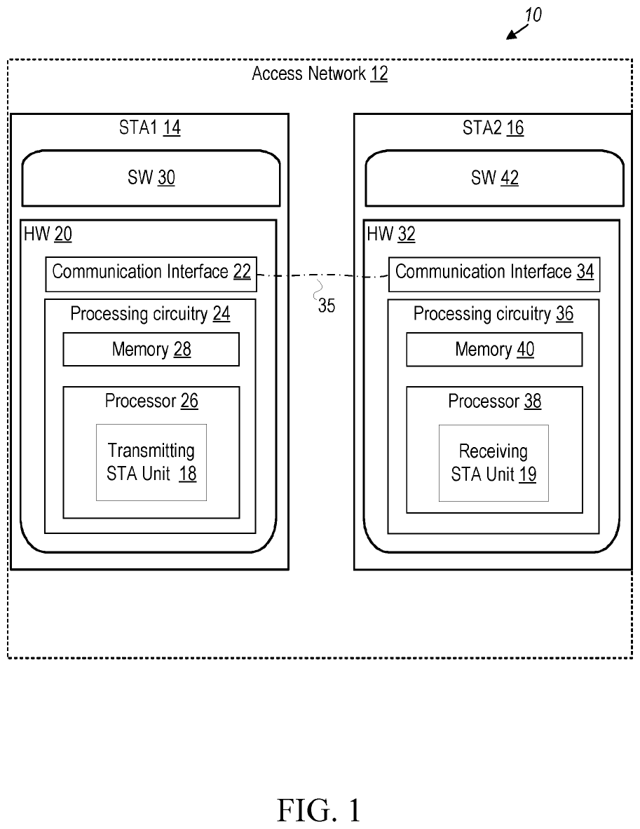

Referring to the drawing figures, in which like elements are referred to by like reference numerals, there is shown in FIG. 1 a block diagram of the communication system 10, according to one embodiment, constructed in accordance with the principles of the present disclosure. The communication system 10 in FIG. 1 is a non-limiting example and other embodiments of the present disclosure may be implemented by one or more other systems and/or networks. Referring to FIG. 1, system 10 may comprise a wireless local area network (WLAN) 12. The devices in the system 10 may communicate over one or more spectrums, such as, for example, an unlicensed spectrum, which may include frequency bands typically used by Wi-Fi technology. One or more of the devices may be further configured to communicate over other frequency bands, such as shared licensed frequency bands, etc. The WLAN 12 includes a STA1 14 and a STA2 16. Note that although a single STA1 14 and a single STA2 16 are shown for convenience, the communication system 10 may include many more STA1 14 and STA2 16. Each STA1 14 may connect to/serve/configure/schedule/etc. one or more STA2 16 (or vice-versa). In some embodiments, STA1 may include identical hardware and/or software as STA2. For example, STA1 and STA2 may be similar models of non-AP STAs, such as a user equipment or mobile terminals, or both STA1 and STA 2 may be APs, such as base stations, etc. In some embodiments, STAI may include one or more different hardware and/or software components compared to STA2. For example, STAI may be an AP or a non-AP STA, whereas STA2 may be a different type of device, such as a non-AP STA or an AP, respectively.

It should be understood that the system 10 may include additional nodes/devices not shown in FIG. 1. In addition, the system 10 may include many more connections/interfaces than those shown in FIG. 1. Thus, the elements shown in FIG. 1 are presented for ease of understanding.

Also, it is contemplated that a STA1 14 and/or a STA2 16 can be in communication and/or configured to separately communicate with more than one STA2 16 and/or more than one type of STA1 14, e.g., for coordination of scheduling, transmission of data or control signaling, RU allocation, etc., which may be via wired and/or wireless communication channels.

A STA1 14 is configured to include a transmitting STA unit 18, which is configured to perform one or more STA1 functions described herein, such as adaptively allocating RUs, e.g., for configuring transmissions to and/or from one or more STA2 16. A STA2 16 is configured to include a receiving STA unit 19, which is configured to perform one or more STA2 16 functions described herein, such as transmitting feedback on RUs to the STA1 14 in accordance with an adaptive RU allocation configuration. In some embodiments, STA1 14 may also include a receiving STA unit 19 (e.g., for use in scenarios where STA1 14 acts as a receiving STA), and STA2 16 may also include a transmitting STA unit 18 (e.g., for use in scenarios where STA2 16 acts as a transmitting STA).

The STA1 14 includes hardware 20 including a communication interface 22, processing circuitry 24, a processor 26, and memory 28. The communication interface 22 may be configured to communicate with any of the nodes/devices in the system 10 according to some embodiments of the present disclosure, such as with one or more other STA1s 14 and/or one or more STA2s 16. In some embodiments, the communication interface 22 may be formed as or may include, for example, one or more radio frequency (RF) transmitters, one or more RF receivers, and/or one or more RF transceivers, and/or may be considered a radio interface. In some embodiments, the communication interface 22 may also include a wired interface.

The processing circuitry 24 may include one or more processors 26 and memory, e.g., memory 28. In addition to a processor 26 and memory 28, the processing circuitry 24 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 26 may be configured to access (e.g., write to and/or read from) the memory 28, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

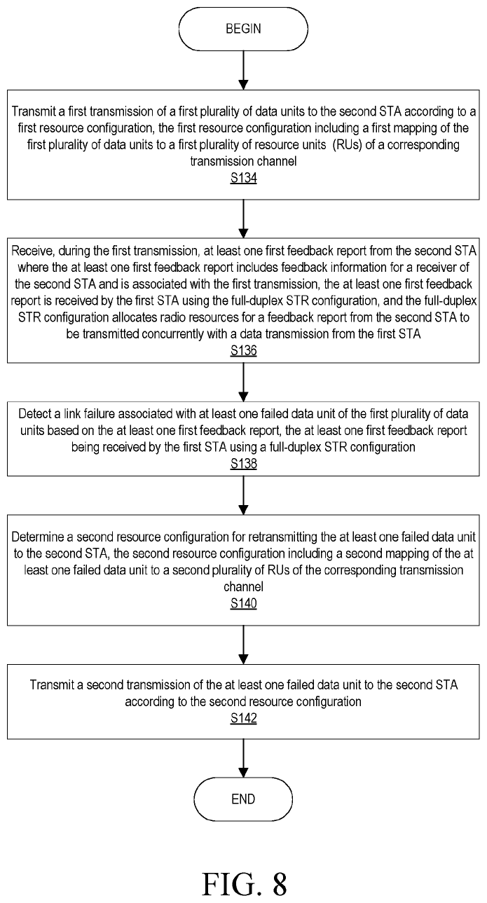

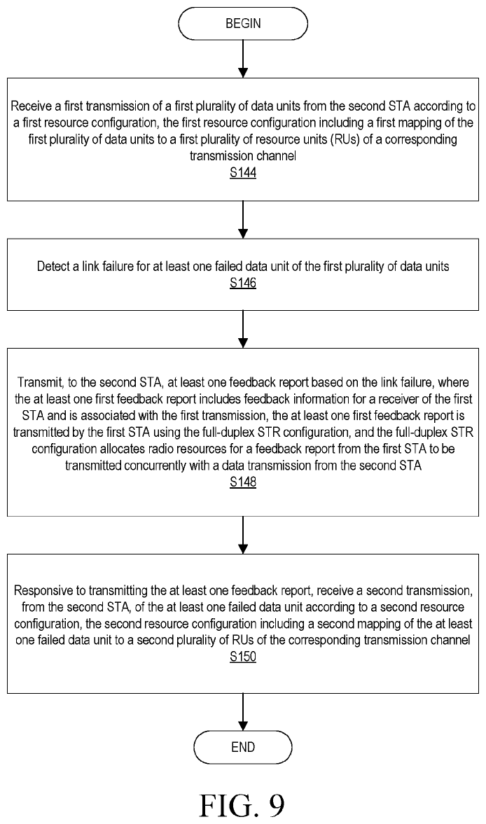

The STA1 14 may further include software 30 stored internally in, for example, memory 28, or stored in external memory (e.g., database) accessible by the STA1 14 via an external connection. The software 30 may be executable by the processing circuitry 24. The processing circuitry 24 may be configured to control any of the methods and/or processes described herein and/or to cause such methods, and/or processes to be performed, e.g., STA1 14. The memory 28 is configured to store data, programmatic software code and/or other information described herein. In some embodiments, the software 30 may include instructions stored in memory 28 that, when executed by the processor 26 and/or transmitting STA unit 18 causes the processing circuitry 24 and/or configures the STA1 14 to perform the processes described herein with respect to the STA1 14 (e.g., processes described with reference to FIG. 8, FIG. 9, and/or any of the other figures herein). In some embodiments, STA1 14 may also include a receiving STA unit 19, e.g., for scenarios where STA1 14 acts as a receiving STA.

Referring still to FIG. 1, the STA2 16 includes hardware 32, which may include a communication interface 34, processing circuitry 36, a processor 38, and memory 40. The communication interface 34 may be configured to communicate with one or more STA1 14, such as via wireless connection 35, and/or with other elements in the system 10, according to some embodiments of the present disclosure. In some embodiments, the communication interface 34 may be formed as or may include, for example, one or more radio frequency (RF) transmitters, one or more RF receivers, and/or one or more RF transceivers, and/or may be considered a radio interface. In some embodiments, the communication interface 34 may also include a wired interface.

The processing circuitry 36 may include one or more processors 38 and memory, such as, the memory 40. Furthermore, in addition to a traditional processor and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the STA2 16 may further include software 42 stored internally in, for example, memory 40, or stored in external memory (e.g., database) accessible by the STA2 16 via an external connection. The software 42 may be executable by the processing circuitry 36. The processing circuitry 36 may be configured to control any of the methods and/or processes described herein and/or to cause such methods, and/or processes to be performed, e.g., by the STA2 16. The memory 40 is configured to store data, programmatic software code and/or other information described herein. In some embodiments, the software may include instructions stored in memory 40 that, when executed by the processor 38 and/or receiving STA unit 19, causes the processing circuitry 36 and/or configures the STA2 16 to perform the processes described herein with respect to the STA2 16 (e.g., processes described with reference to FIG. 8, FIG. 9, and/or any of the other figures herein). In some embodiments, STA2 16 may also be configured with transmitting STA unit 18, e.g., for scenarios where STA2 16 acts as a transmitting STA.

In FIG. 1, the connection between the devices STA1 14 and the STA2s 16 is shown without explicit reference to any intermediary devices or connections. However, it should be understood that intermediary devices and/or connections may exist between these devices, although not explicitly shown.

Although FIG. 1 shows transmitting STA unit 18 and receiving STA unit 19, as being within a respective processor, it is contemplated that this element may be implemented such that a portion of the element is stored in a corresponding memory within the processing circuitry. In other words, the element may be implemented in hardware or in a combination of hardware and software within the processing circuitry.

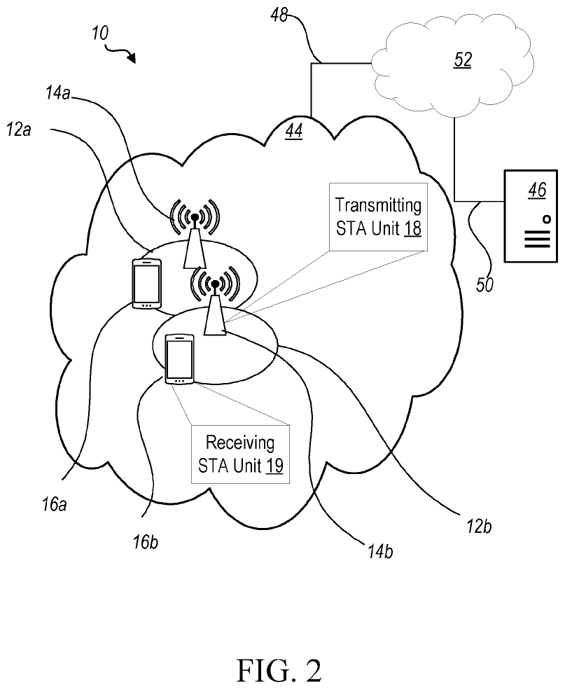

FIG. 2 is a schematic diagram of a communication system 10, according to some embodiments of the present disclosure. In the example of FIG. 2, STA1 14 and STA2s 16 may be similar to those of the example of FIG. 1, described herein. In some embodiments, STA1 14 may be an access point (AP) and STA2 16 may be a non-AP STA, but are not limited to these types of devices. For example, STA1 14 may be a non-AP STA, and STA2 16 may be an AP, or both may be APs, both may be non-AP STAs, etc. Further, the classification of a device as an AP and/or as a non-AP STA may depend on the context or configuration.

Additionally, in the example of FIG. 2, one or more STA1s 14 and/or STA2s 16 may form and/or be part of a service set network 44 (e.g., a basic service set, or any other network, set, and/or grouping of STA1s 14 and STA2s 16). The communication system 10 and/or service set network 44 may itself be connected to a host computer 46, which may be embodied in the hardware and/or software of a standalone server, a cloud-implemented server, a distributed server or as processing resources in a server farm. The host computer 46 may be under the ownership or control of a service provider, or may be operated by the service provider or on behalf of the service provider. The connections 48, 50 between the communication system 10 and/or the service set network 44 and the host computer 46 may extend directly from the service set network 44 to the host computer 46 or may extend via an optional intermediate network 52. The intermediate network 52 may be one of, or a combination of more than one of, a public, private or hosted network. The intermediate network 52, if any, may be a backbone network or the Internet. In some embodiments, the intermediate network 52 may comprise two or more sub-networks (not shown).

The communication system of FIG. 2 as a whole enables connectivity between one of the connected STA2s 16 and the host computer 46. The connectivity may be described as an over-the-top (OTT) connection. The host computer 46 and the connected STA2s 16 are configured to communicate data and/or signaling via the OTT connection, using the service set network 44, any intermediate network 52 and possible further infrastructure (not shown) as intermediaries. The OTT connection may be transparent in the sense that at least some of the participating communication devices through which the OTT connection passes are unaware of routing of uplink and downlink communications. For example, an STA1 14 may not or need not be informed about the past routing of an incoming downlink communication with data originating from a host computer 46 to be forwarded (e.g., handed over) to a connected STA2 16. Similarly, the STA1 14 need not be aware of the future routing of an outgoing uplink communication originating from the STA2 16 towards the host computer 46.

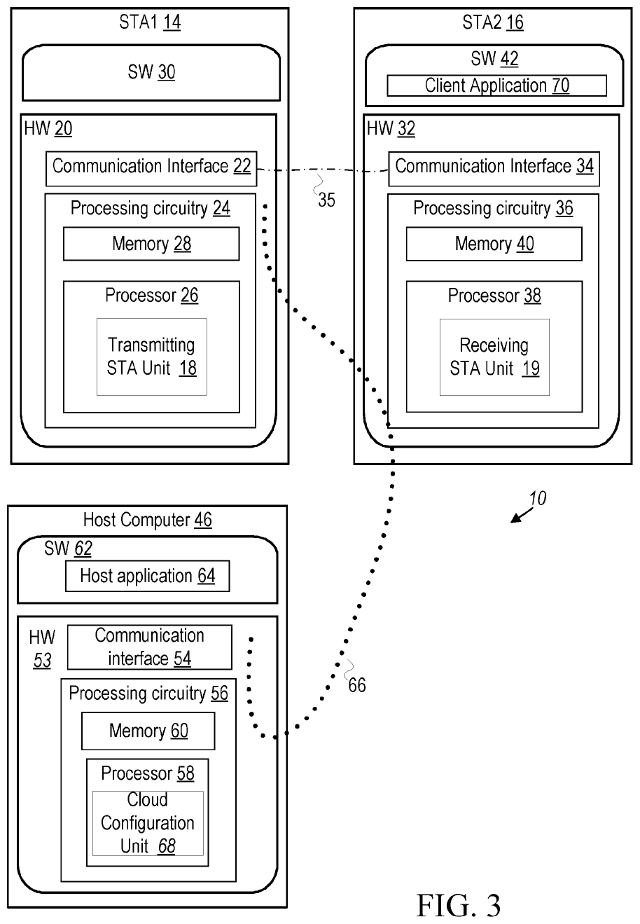

Example implementations, in accordance with an embodiment, of the STA2 16, STA1 14, and host computer 46 discussed in the preceding paragraphs will now be described with reference to FIG. 3. In the example of FIG. 3, the STA1 14 and the STA2 16 may have similar features and components as the STA1 14 and STA2 16 depicted in FIG. 1. Additionally, the host computer 46 comprises hardware (HW) 53 including a communication interface 54 configured to set up and maintain a wired or wireless connection with an interface of a different communication device of the communication system 10. The host computer 46 further comprises processing circuitry 56, which may have storage and/or processing capabilities. The processing circuitry 56 may include a processor 58 and memory 60. In particular, in addition to or instead of a processor, such as a central processing unit, and memory, the processing circuitry 56 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 58 may be configured to access (e.g., write to and/or read from) memory 60, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 56 may be configured to control any of the methods and/or processes described herein and/or to cause such methods, and/or processes to be performed, e.g., by host computer 46. Processor 58 corresponds to one or more processors 58 for performing host computer 46 functions described herein. The host computer 46 includes memory 60 that is configured to store data, programmatic software code and/or other information described herein. In some embodiments, the software 62 and/or the host application 64 may include instructions that, when executed by the processor 58 and/or processing circuitry 56, causes the processor 58 and/or processing circuitry 56 to perform the processes described herein with respect to host computer 46. The instructions may be software associated with the host computer 46.

The software 62 of host computer 46 may be executable by the processing circuitry 56. The software 62 includes a host application 64. The host application 64 may be operable to provide a service to a remote user, such as a STA2 16 connecting via an OTT connection 66 terminating at the STA2 16 and the host computer 46. In providing the service to the remote user, the host application 64 may provide user data which is transmitted using the OTT connection 66. The “user data” may be data and information described herein as implementing the described functionality. In one embodiment, the host computer 46 may be configured for providing control and functionality to a service provider and may be operated by the service provider or on behalf of the service provider. The processing circuitry 56 of the host computer 46 may enable the host computer 46 to observe, monitor, control, transmit to and/or receive from the STA1 14 and/or the STA2 16. The processing circuitry 56 of the host computer 46 may include a Cloud Configuration unit 68 configured to enable the service provider to observe/monitor/control/transmit to/receive from/configure/etc. the STA1 14 and/or the STA2 16.

The communication interface 22 of STA1 14 may be configured to facilitate a connection 66 to the host computer 46. The connection 66 may be direct or it may pass through a service set network 44 of the communication system 10 and/or through one or more intermediate networks 52 outside the communication system 10. The communication interface 34 of STA2 16 may be configured to facilitate a connection 66 to the host computer 46. The connection 66 may be direct or it may pass through a service set network 44 of the communication system 10 and/or through one or more intermediate networks 52 outside the communication system 10.

The software 42 of STA2 16 may include a client application 70. The client application 70 may be operable to provide a service to a human or non-human user via the STA2 16, with the support of the host computer 46. In the host computer 46, an executing host application 64 may communicate with the executing client application 70 via the OTT connection 66 terminating at the STA2 16 and the host computer 46. In providing the service to the user, the client application 70 may receive request data from the host application 64 and provide user data in response to the request data. The OTT connection 66 may transfer both the request data and the user data. The client application 70 may interact with the user to generate the user data that it provides.

In some embodiments, the inner workings of the STA1 14, STA2 16, and host computer 46 may be as shown in FIG. 3 and independently, the surrounding network topology may be that of FIG. 2.

In FIG. 3, the OTT connection 66 has been drawn abstractly to illustrate the communication between the host computer 46 and the STA2 16 via the STA1 14, without explicit reference to any intermediary devices and the precise routing of messages via these devices. Network infrastructure may determine the routing, which it may be configured to hide from the STA2 16 or from the service provider operating the host computer 46, or both. While the OTT connection 66 is active, the network infrastructure may further take decisions by which it dynamically changes the routing (e.g., on the basis of load balancing consideration or reconfiguration of the network).

The wireless connection 35 between the STA2 16 and the STA1 14 is in accordance with the teachings of the embodiments described throughout this disclosure. One or more of the various embodiments improve the performance of OTT services provided to the STA2 16 using the OTT connection 66, in which the wireless connection 35 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 66 between the host computer 46 and STA2 16, in response to variations in the measurement results. The measurement procedure and/or the network functionality for reconfiguring the OTT connection 66 may be implemented in the software 62 of the host computer 46 or in the software 42 of the STA2 16, or both. In embodiments, sensors (not shown) may be deployed in or in association with communication devices through which the OTT connection 66 passes; the sensors may participate in the measurement procedure by supplying values of the monitored quantities exemplified above, or supplying values of other physical quantities from which software 62, 42 may compute or estimate the monitored quantities. The reconfiguring of the OTT connection 66 may include message format, retransmission settings, preferred routing etc.; the reconfiguring need not affect the STA1 14, and it may be unknown or imperceptible to the STA1 14. Some such procedures and functionalities may be known and practiced in the art. In certain embodiments, measurements may involve proprietary wireless device signaling facilitating the host computer's 46 measurements of throughput, propagation times, latency and the like. In some embodiments, the measurements may be implemented in that the software 62, 42 causes messages to be transmitted, in particular empty or ‘dummy’ messages, using the OTT connection 66 while it monitors propagation times, errors, etc.

Thus, in some embodiments, the host computer 46 includes processing circuitry 56 configured to provide user data and a communication interface 54 that is configured to forward the user data to a wireless network and/or cellular network for transmission to the STA2 16. In some embodiments, the wireless network and/or cellular network also includes the STA1 14 with a communication interface 22. In some embodiments, the STA1 14 is configured to, and/or the STA1 14 processing circuitry 24 is configured to perform the functions and/or methods described herein for preparing/initiating/maintaining/supporting/ending a transmission to the STA2 16, and/or preparing/terminating/maintaining/supporting/ending in receipt of a transmission from the STA2 16.

In some embodiments, the host computer 46 includes processing circuitry 56 and a communication interface 54 that is configured to receive user data originating from a transmission from a STA2 16 to an STA1 14. In some embodiments, the STA2 16 is configured to, and/or comprises a communication interface 34 and/or processing circuitry 36 configured to perform the functions and/or methods described herein for preparing/initiating/maintaining/supporting/ending a transmission to the STA1 14, and/or preparing/terminating/maintaining/supporting/ending in receipt of a transmission from the STA1 14.

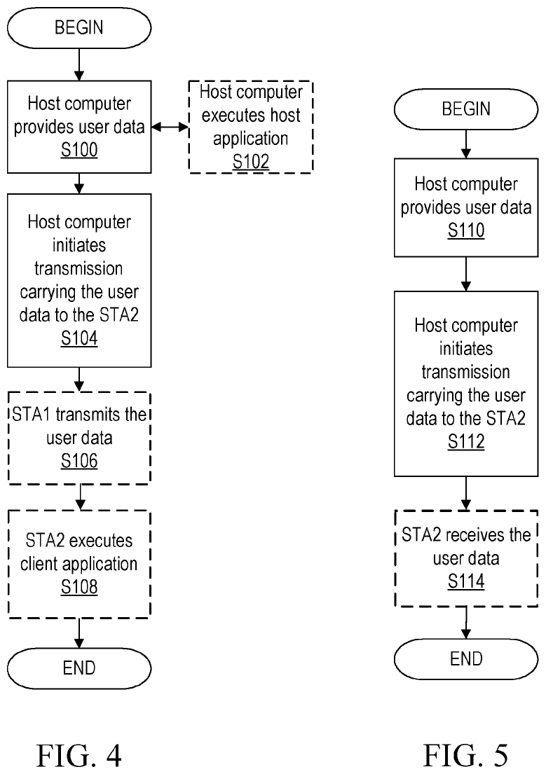

FIG. 4 is a flowchart illustrating an example method implemented in a communication system, such as, for example, the communication system of FIGS. 2 and 3, in accordance with one embodiment. The communication system may include a host computer 46, an STA1 14 and a STA2 16, which may be those described with reference to FIG. 3. In a first step of the method, the host computer 46 provides user data (Block S100). In an optional substep of the first step, the host computer 46 provides the user data by executing a host application, such as, for example, the host application 64 (Block S102). In a second step, the host computer 46 initiates a transmission carrying the user data to the STA2 16 (Block S104). In an optional third step, the STA1 14 transmits to the STA2 16 the user data which was carried in the transmission that the host computer 46 initiated, in accordance with the teachings of the embodiments described throughout this disclosure (Block S106). In an optional fourth step, the STA2 16 executes a client application, such as, for example, the client application 70, associated with the host application 64 executed by the host computer 46 (Block S108).

FIG. 5 is a flowchart illustrating an example method implemented in a communication system, such as, for example, the communication system of FIG. 3, in accordance with one embodiment. The communication system may include a host computer 46, an STA1 14, and a STA2 16. In a first step of the method, the host computer 46 provides user data (Block S110). In an optional substep (not shown) the host computer 46 provides the user data by executing a host application, such as, for example, the host application 64. In a second step, the host computer 46 initiates a transmission carrying the user data to the STA2 16 (Block S112). The transmission may pass via the STA1 14, in accordance with the teachings of the embodiments described throughout this disclosure. In an optional third step, the STA2 16 receives the user data carried in the transmission (Block S114).

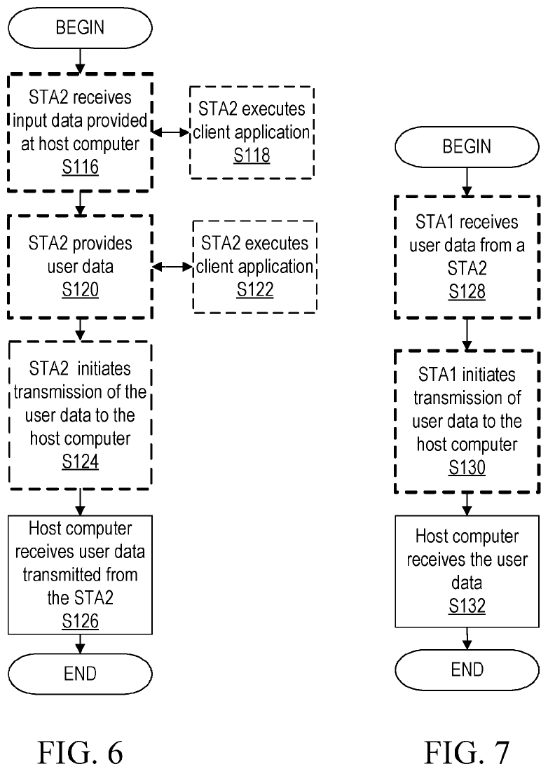

FIG. 6 is a flowchart illustrating an example method implemented in a communication system, such as, for example, the communication system of FIG. 3, in accordance with one embodiment. The communication system may include a host computer 46, an STA1 14 and a STA2 16. In an optional first step of the method, the STA2 16 receives input data provided by the host computer 46 (Block S116). In an optional substep of the first step, the STA2 16 executes the client application 70, which provides the user data in reaction to the received input data provided by the host computer 46 (Block S118). Additionally or alternatively, in an optional second step, the STA2 16 provides user data (Block S120). In an optional substep of the second step, the STA2 16 provides the user data by executing a client application, such as, for example, client application 70 (Block S122). In providing the user data, the executed client application 70 may further consider user input received from the user. Regardless of the specific manner in which the user data was provided, the STA2 16 may initiate, in an optional third substep, transmission of the user data to the host computer 46 (Block S124). In a fourth step of the method, the host computer 46 receives the user data transmitted from the STA2 16, in accordance with the teachings of the embodiments described throughout this disclosure (Block S126).

FIG. 7 is a flowchart illustrating an example method implemented in a communication system, such as, for example, the communication system of FIG. 3, in accordance with one embodiment. The communication system may include a host computer 46, an STA1 14 and a STA2 16. In an optional first step of the method, in accordance with the teachings of the embodiments described throughout this disclosure, the STA1 14 receives user data from the STA2 16 (Block S128). In an optional second step, the STA1 14 initiates transmission of the received user data to the host computer 46 (Block S130). In a third step, the host computer 46 receives the user data carried in the transmission initiated by the STA1 14 (Block S132).

FIG. 8 is a flowchart of an example process in a first STA1 14 (e.g., a transmitting STA, such as an AP or a non-AP STA) for supporting configurations for Adaptive RU allocation with one or more second STA2s 16 (e.g., receiving STAs, such as an AP or a non-AP STA). Thus, one or more Blocks and/or functions and/or methods performed by the first STA1 14 may be performed by one or more elements of STA1 14, such as by transmitting STA unit 18 in processing circuitry 24, memory 28, processor 26, communication interface 22, etc. The first STA1 14 may be an STR-capable device which selects, determines, and/or is configured with (e.g., preconfigured, configured by another station, etc.) a full-duplex STR configuration. For example, the first STA1 14 may be configured to one or more of receive, determine, select, modify, allocate, etc., the STR configuration and/or one or more aspects of the STR configuration (e.g., the first STA1 14 determines/selects which radio resources, resource units, etc., in an STR configuration, to allocate to a second STA2 16, for feedback reporting, data transmission/reception, and/or other actions related to simultaneous transmission and reception). The first STA1 14 is configured to transmit a first transmission (Block S134) of a first plurality of data units to the second STA2 16 according to a first resource configuration, where the first resource configuration includes a first mapping of the first plurality of data units to a first plurality of resource units (RUs) of a corresponding transmission channel, receive (Block S136), during the first transmission, at least one first feedback report from the second STA2 16 for the first transmission, where the at least one first feedback report includes feedback information for a receiver (e.g., a receiver of communication interface 34) of the second STA2 16 and is associated with the first transmission, the at least one first feedback report is received by the first STA1 14 using the full-duplex STR configuration, and the full-duplex STR configuration allocates radio resources for a feedback report from the second STA2 16 to be transmitted concurrently with a data transmission from the first STA1 14 (e.g., received simultaneously without interrupting the first transmission, as described herein). The first STA1 14 is configured to detect (Block S138) a link failure associated with at least one failed data unit of the first plurality of data units based on the at least one first feedback report, determine (Block S140) a second resource configuration for retransmitting the at least one failed data unit to the second STA2 16, where the second resource configuration includes a second mapping of the at least one failed data unit to a second plurality of RUs of the corresponding transmission channel, and transmit a second transmission (Block S142) of the at least one failed data unit to the second STA2 16 according to the second resource configuration.

In one or more embodiments, the first STA1 14 is one of an access point (AP) and a non-AP STA, and the second STA2 16 is one of an AP and a non-AP STA.

In one or more embodiments, the first STA1 14 is further configured to receive the at least one first feedback report from the second STA2 16 during the first transmission when the second STA2 16 is an STR-capable device and/or full-duplex-capable device which is capable of transmitting the at least one first feedback report (e.g., a first feedback report, at least one of a plurality of feedback reports, etc., associated with the data transmission from STA1 to STA2) while continuing to receive the first transmission from the first STA1 14.

In one or more embodiments, the first STA1 14 is further configured to interrupt the first transmission based on the detection of the link failure.

In one or more embodiments, the full-duplex STR configuration corresponds to one or more of a frequency division duplexing (FDD) configuration, an in-band full-duplex (IBFD) configuration, and a subband full duplex (SBFD) configuration.

In one or more embodiments, the at least one first feedback report includes at least one of a bitmap indicating acknowledgment information for at least a subset of the first plurality of data units, interference information associated with at least one RU of the first plurality of RUs, measurement information associated with at least one RU of the first plurality of RUs, an indication of a failure to decode the at least one failed data unit, and an indication of a successful reception of at least one successful data unit of the first plurality of data units.

In one or more embodiments, the detecting of the reception failure includes detecting a failure to receive at least one expected feedback report from the second STA2 16 for at least one of the first plurality of data units. In one or more embodiments, the determining of the second resource configuration includes puncturing a first RU of the first plurality of RUs based on the link failure being associated with at least one failed data unit transmitted on at least the first RU. In one or more embodiments, the second transmission further includes a second plurality of data units, where the second plurality of data units is transmitted according to the second resource configuration, and the second mapping of the second resource configuration further maps the second plurality of data units to the second plurality of RUs. In one or more embodiments, the first STA1 14 is further configured to at least one of transmit, to the second STA2 16, a first indication of the first resource configuration, transmit, to the second STA2 16, a second indication of the second resource configuration, and transmit, to the second STA2 16, a third indication of the full-duplex STR configuration.

In one or more embodiments, the second indication further indicates at least one of a time until switching from the first resource configuration to the second resource configuration, a Short Interframe Space (SIFS) time between consecutive feedback reports, and (an indication of) whether each data unit of the second transmission is contained within a single RU. In one or more embodiments, the first STA1 14 is further configured to transmit, to the second STA2 16 and at least one additional STA2 16, a feedback reporting configuration, the feedback reporting configuration configuring the second STA2 16 and the at least one additional STA2 16 to avoid collisions in feedback reporting to the first STA1 14. In one or more embodiments, each of the first plurality of data units is associated with a corresponding feedback report of a first plurality of feedback reports expected from the second STA2 16, and the first STA1 14 is further configured to attempt to receive each of the first plurality of feedback reports subsequent to transmission of the corresponding data unit of the first plurality of data units, each attempted reception of the first plurality of feedback reports being optionally separated by a Short Interframe Space (SIFS) time.

In one or more embodiments, the first STA1 14 is further configured to detect a missing feedback report of the first plurality of feedback reports, where the missing feedback report is associated with at least one first RU of the first plurality of RUs, and responsive to detecting the missing feedback report, transmit the second resource configuration to the second STA2 16, where the second resource configuration includes a puncturing of the at least one first RU. In one or more embodiments, the at least one first feedback report is received from the second STA2 16 on a control RU (e.g., according to the STR configuration), which is separate from the first plurality of RUs. In one or more embodiments, the first STA1 14 is further configured to transmit a trigger indication to the second STA2 16 using the control RU (e.g., according to the STR configuration), and receive the at least one first feedback report in response to the trigger indication. In one or more embodiments, the first plurality of RUs include at least one first RU and at least one second RU, the link failure being associated with interference in the at least one first RU, and the second plurality of RUs excluding the at least one first RU.

In one or more embodiments, the second resource configuration modifies at least one of a timing configuration of the first resource configuration, a bandwidth of the first resource configuration, a puncturing configuration of the first resource configuration, a modulation coding scheme (MCS) of the first resource configuration, and an ordering of transmission of the first plurality of data units of the first resource configuration.

In one or more embodiments, the first mapping includes one of each data unit of the first plurality of data units being mapped to a corresponding single RU of the first plurality of RUs, and each data unit of the first plurality of data units being mapped to multiple RUs of the first plurality of RUs. In one or more embodiments, the first STA1 14 is further configured to receive a second feedback report from the second STA2 16, and revert to the first resource configuration based on the second feedback report.

In one or more embodiments, the first plurality of data units correspond to a first plurality of codewords of a physical layer protocol data unit (PPDU).

FIG. 9 is a flowchart of an example process in a first STA2 16 for supporting configurations for Adaptive RU allocation. Thus, one or more Blocks and/or functions and/or methods performed by the first STA2 16 may be performed by one or more elements of STA2 16 such as by receiving STA unit 19 in processing circuitry 36 memory 40, processor 38, communication interface 34, etc. according to the example process/method. The first STA2 16 may be configured with a full-duplex STR configuration (e.g., preconfigured, based on signaling/indications received from other stations, such as an STA1 14, etc.). The first STA2 16 is configured to receive (Block S144) a first transmission of a first plurality of data units from the second STA1 14 according to a first resource configuration, the first resource configuration including a first mapping of the first plurality of data units to a first plurality of resource units (RUs) of a corresponding transmission channel, detect (Block S146) a link failure for at least one failed data unit of the first plurality of data units, transmit (Block S148), to the second STA1 14, at least one first feedback report based on the link failure and the at least one first feedback report including feedback information for a receiver (e.g., a receiver of communication interface 34) of the first STA2 16 and associated with the first transmission, the at least one first feedback report being transmitted by the first STA2 16 using the full-duplex STR configuration, the full-duplex STR configuration allocating radio resources for the at least one first feedback report from the first STA2 16 to be transmitted concurrently with a data transmission from the second STA1 14, and, responsive to transmitting the at least one first feedback report, receive (Block S150) a second transmission, from the second STA1 14, of the at least one failed data unit according to a second resource configuration, where the second resource configuration includes a second mapping of the at least one failed data unit to a second plurality of RUs of the corresponding transmission channel.

In one or more embodiments, the first STA2 16 is one of an access point (AP) and a non-AP STA, and the second STA1 14 is one of an AP and a non-AP STA.

In one or more embodiments, the first STA2 16 is further configured to transmit the at least one first feedback report from the first STA2 16 to the second STA1 14 without interrupting the receiving of the first transmission when the first STA2 16 is an STR-capable device and/or full-duplex-capable device.

In one or more embodiments, the full-duplex STR configuration corresponds to one or more of a frequency division duplexing (FDD) configuration, an in-band full-duplex (IBFD) configuration, and a subband full duplex (SBFD) configuration.

According to one or more embodiments of the present disclosure, the at least one first feedback report includes at least one of a bitmap indicating acknowledgment information for at least a subset of the first plurality of data units, interference information associated with at least one RU of the first plurality of RUs, measurement information associated with at least one RU of the first plurality of RUs, an indication of a failure to decode the at least one failed data unit, and an indication of a successful reception of at least one successful data unit of the first plurality of data units.

In one or more embodiments, the second resource configuration includes a puncturing of a first RU of the first plurality of RUs based on at least one failed data unit being mapped to at least the first RU according to the first mapping. In one or more embodiments, the second transmission further includes a second plurality of data units, the second plurality of data units being received according to the second resource configuration, the second mapping of the second resource configuration further mapping the second plurality of data units to the second plurality of RUs.

In one or more embodiments, the first STA2 16 is further configured to at least one of receive, from the second STA1 14, a first indication of the first resource configuration, receive, from the second STA1 14, a second indication of the second resource configuration, and receive, from the second STA STA1 14 a third indication of the full-duplex STR configuration. In one or more embodiments, the second indication further indicates at least one of a time until switching from the first resource configuration to the second resource configuration, a Short Interframe Space (SIFS) time between consecutive feedback reports, and whether each data unit of the second transmission is contained within a single RU.

In one or more embodiments, the first STA2 16 is further configured to receive, from the second STA1 14, a feedback reporting configuration, the feedback reporting configuration configuring the second STA1 14 and at least one additional STA to avoid collisions in feedback reporting to the first STA2 16.

In one or more embodiments, each of the first plurality of data units is associated with a corresponding feedback report of a first plurality of feedback reports to be transmitted from the first STA2 16, and the first STA2 16 is further configured to transmit each of the first plurality of feedback reports to the second STA1 14, each transmission of each corresponding feedback report being optionally separated by a Short Interframe Space (SIFS) time.

In one or more embodiments, the at least one first feedback report is transmitted to the second STA1 14 on a control RU (e.g., according to the STR configuration) which is separate from the first plurality of RUs. In one or more embodiments, the first STA2 16 is a simultaneous transmission and reception (STR) device, and the first STA2 16 is further configured to transmit the at least one first feedback report while continuing to receive the first transmission from the second STA1 14.

In one or more embodiments, the first STA2 16 is further configured to receive a trigger indication from the second STA1 14 on the control RU (e.g., according to the STR configuration), and transmit at least one first feedback report to the second STA1 14 in response to the trigger indication. In one or more embodiments, the first plurality of RUs include at least one first RU and at least one second RU, the link failure is associated with interference in the at least one first RU, and the second plurality of RUs excludes the at least one first RU.

In one or more embodiments, the second resource configuration modifies at least one of a timing configuration of the first resource configuration, a bandwidth of the first resource configuration, a puncturing configuration of the first resource configuration, a modulation coding scheme (MCS) of the first resource configuration, and an ordering of transmission of the first plurality of data units of the first resource configuration.

In one or more embodiments, the first mapping includes one of each data unit of the first plurality of data units being mapped to a corresponding single RU of the first plurality of RUs, and each data unit of the first plurality of data units being mapped to multiple RUs of the first plurality of RUs.

In one or more embodiments, the first STA2 16 is further configured to transmit a second feedback report to the second STA1 14, and revert to the first resource configuration based on the second feedback report. In one or more embodiments, the first plurality of data units correspond to a first plurality of codewords of a physical layer protocol data unit (PPDU).

Having described the general process flow of arrangements of the disclosure and having provided examples of hardware and software arrangements for implementing the processes and functions of the disclosure, the sections below provide details and examples of arrangements for supporting configurations for Adaptive RU allocation.

Some embodiments of the present disclosure will be described as applied to a system based on IEEE 802.11, also commonly referred to as Wi-Fi. Thus, a network node may be denoted as an “AP” (e.g., STA1 14 or STA2 16) and a device connected to an access point, such as user device (wireless device, user equipment, etc.), is denoted as a “non-AP STA” (e.g., STA1 14 or STA2 16). The use of this terminology is intended to be non-limiting, and embodiments of the present disclosure may also be applied to other types of network architectures, e.g., 3GPP networks, without deviating from the scope of the present disclosure.

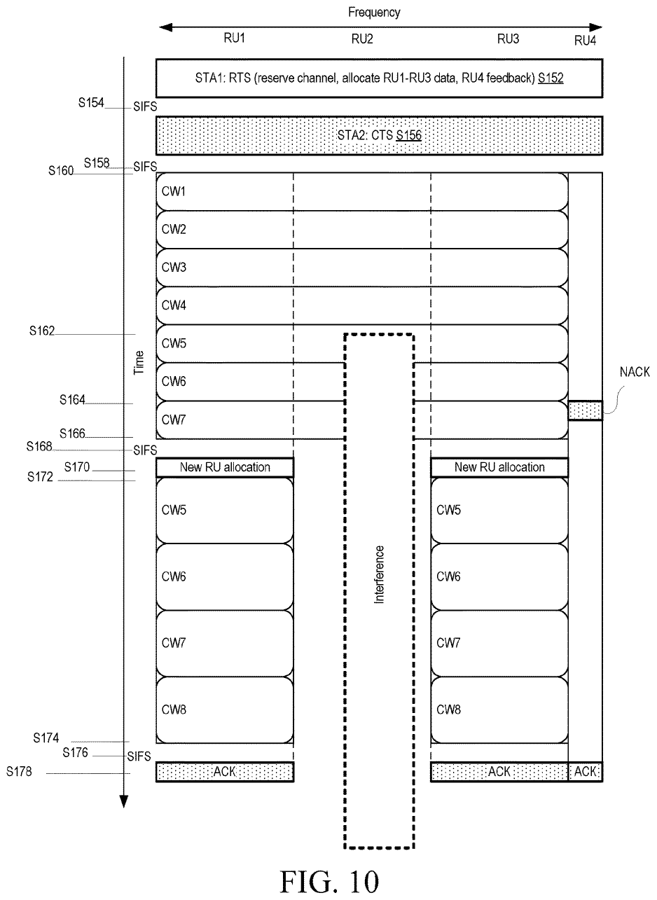

An example operation of a first embodiment is illustrated in the signaling diagram of FIG. 10. In this example, one or both of STA1 14 and STA2 16 may be capable of simultaneous transmission and reception. As an illustrative example, in FIG. 10, the channel bandwidth may be 260 MHz. This bandwidth is merely an example and other bandwidths may be used without deviating from the scope of the present disclosure. The STA1 14 may be configured to determine a configuration for transmitting signaling to one or more STA2s 16 which includes dividing the channel bandwidth (e.g., of 260 MHz) into a plurality of RUs. For example, the STA1 14 may divide the channel into four RUs, including three RUS (RU1-RU3) of 80 MHz each, and a fourth RU (RU4) of 20 MHz. Other channel bandwidths and quantities of RUs may be applied, as configured and as appropriate.

In some embodiments, when STA1 14 gains access to the medium, it may be configured to send a frame or other signaling to reserve the channel (e.g., a Request-To-Send, RTS, to obtain a Transmission Opportunity, TXOP), which may signal the RU allocation to the STA2 16 (Step S152 of FIG. 10). According to this reservation of RUs (i.e., a transmission configuration), RU1, RU2, and RU3 are used by the STA1 14 to transmit data (e.g., “critical” data), while RU4 may be used by the STA2 16 to send feedback to the STA1 14.

Following a short interframe spacing (SIFS) time period (Step S154), STA2 16 transmits (Step S156) a clear to send (CTS) signaling, which may be received by STA1 14 and/or other device(s), and which may indicate that STA2 16 is ready to receive the transmission (e.g., “downlink” transmission) from STA1 14.

Following a SIFS (Step S158), the STA1 14 begins transmitting the data (Step S160) using, e.g., RU1, RU2, and RU3 for each codeword. The data (e.g., critical data) may be encoded, e.g., in a plurality of LDPC codewords (in this example, 8 codewords labeled CW1 CW8 in FIG. 10), that which be packed into one (or more) physical layer protocol data unit (PPDU), for example. The encoding may be performed over the whole bandwidth in order to exploit frequency diversity, in some embodiments. The receiver may initiate decoding as soon as each codeword is received (e.g., as is typical of many 802.11 receivers).

During the transmission of the data, at Step S162, interference occurs in RU2. At Step S164, the STA2 16 transmits feedback (e.g., a NACK indication) to the STA1 14. The NACK feedback may indicate a failure to receive or decode CW5, CW6, and/or CW7, e.g., due to the interference in RU2. At Step S166, the STA1 14 ceases transmission of the data. Following a SIFS (Step S168), the STA1 14 signals a new RU allocation (which the STA1 14 may have determined based on the NACK signaling, for example) to the STA2 16 and/or other devices. The new RU allocation may be signaled on RU1 and RU3, but not on RU2, for example. At Step S172, the STA1 14 begins transmitting data, using RU1 and RU3 but not RU2. In the example of FIG. 10, according to the new RU allocation, each codeword is sent such that a portion of the codeword is sent on RU1 and a portion is sent on RU3.

At Step 174, the data transmission is complete (with CW8), and following a SIFS (Step S176), the STA2 16 sends a feedback information, e.g., by sending ACK information on RU1 and RU3, and/or on RU4, but not on RU2 due to the continued interference and/or in accordance with the new RU allocation.

In the example of FIG. 10, interference appears as depicted by the dashed box. Due to the presence of interference, in this example, the decoding of the codewords CW5-CW7 by STA2 16 fails. For example, the receiver STA2 16 may perform a parity check, and/or a Cyclic Redundancy Check (CRC) may be added to each codeword, which is used to detect an error in the reception of the codewords. When STA2 16 detects that CW5 is in error, it may be configured to transmit a negative acknowledgement (NACK) to STA1 14, in RU4 (or more generally, in whichever RU(s) has/have been reserved for feedback), indicating that CW5 was not correctly decoded. In addition, STA2 16 is configured to detect the presence of interference in each of RU1-RU3 (or more generally, in which RU(s) has/have been reserved for data, such as critical data). This may be performed, for example, by computing statistics for the soft values, the SINR, the average power, etc., and determining whether the error rate and/or signal interference exceeds a threshold. In the example of FIG. 10, STA2 16 informs STA1 14 via the NACK that the channel is poor in RU2. After receiving the feedback report, STA1 14 may be configured to interrupt the transmission based on the feedback report and determine a new RU allocation consisting of RU1 and RU3 (i.e., without RU2). Then STA1 14 transmits a new PPDU indicating the new RU allocation and including CW5 to CW8. The time between successive transmissions is configured according to a short interframe spacing (SIFS) to prevent other stations from accessing the medium.

In some embodiments, if a NACK/ACK is lost in the transmission from STA2 16 to STA1 14, STA2 16 may repeat the NACK/ACK until it has the correct frames. In the example of FIG. 10, for example, if NACK is lost (e.g., not received by the STA1 14, due to interference or other causes of failure), after CW7, STA2 16 may be configured to send a new NACK including both CW5 and CW6 (and CW7, e.g., if it has time to decode it). Thus, when a NACK is lost, the consecutive NACK may include more CWs in its report (e.g., than the prior report).

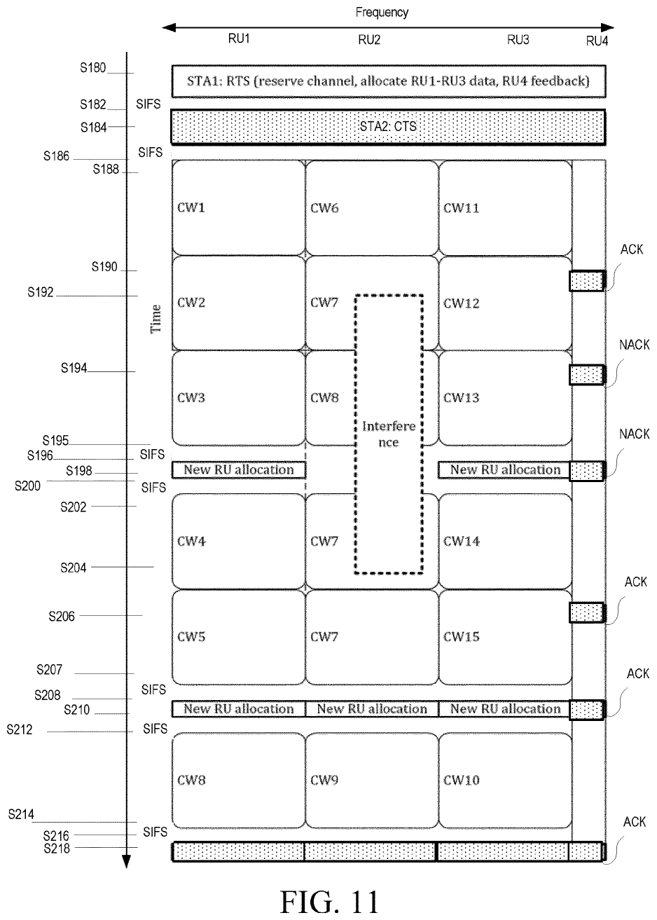

An example configuration according to a second embodiment of the present disclosure is illustrated in the signaling diagram of FIG. 11. In Step S180, STA1 14 transmits RTS information reserving the channel, allocation RU1-RU3 for data, and RU4 for feedback. Following a SIFS (Step S182), the STA2 16 transmits a CTS (Step S184). Following another SIFS (Step S186), the STA1 14 begins transmitting the data. In this example, each codeword is sent on one of the three RUs available for data. For example, CW1 is sent on RU1, CW6 is sent on RU2, and CW11 is sent on RU3 during a first time period. STA2 16 transmits feedback (e.g., an ACK signal) on RU4 at Step S190, which may contain feedback for, e.g., CW1, CW6, and CW11. Interference in RU2 begins at Step S192, which may affect the ability of STA2 16 to receive and/or decode CW7, for example. In some embodiments, STA2 may be able to receive or decode the codewords even in the presence of interference, but may nevertheless indicate the presence of the interference to the STA1, which may consequently determine whether to continue transmitting on the channel exhibiting interference or to determine a new RU allocation. At Step S194, STA2 16 transmits feedback (e.g., a NACK) on RU4 indicating interference in RU2 (and/or a failure to receive or decode the codewords in RU2). STA1 14 may pause transmission of the data at Step S195 responsive to the NACK signaling, and following a SIFS (Step S196), transmits (Step S198) a new RU allocation (e.g., which may be determined based on the feedback, configuration information, etc.), which may be transmitted to STA2 16 on RU1 and RU3 (and/or RU2, in some embodiments). Following another SIFS (Step S200), STA1 14 begins transmitting more data (e.g., CW4, CW7, and CW14) using RU1, RU2, and RU3, respectively. In this example, the STA1 14 may be configured to continue transmitting on RU2 despite the presence of interference. For example, the feedback may indicate that the interference is above a first threshold (e.g., corresponding to a moderately high but still tolerable level of interference), but below a second threshold (e.g., corresponding to a very high and intolerable level of interference), which may trigger STA1 14 to continue transmitting on RU2. In some embodiments, STA1 14 may be configured to, in response to receiving such feedback from STA2 16 indicating the interference on RU2 is above the first threshold and below the second threshold, continue the transmission on RU2, but using one or more different transmission parameters (e.g., coding schemes, error protection schemes, etc.), which may be applied to RU2 and/or the other channels. In some embodiments, STA1 14 may be configured to cease transmission on RU2 until interference levels fall below some preconfigured threshold level. The interference in RU2 stops at Step S204 (e.g., falls below some threshold level). At Step S206, the STA2 16 transmits feedback (e.g., an ACK signaling) indicating that the CW7 was received/decoded correctly in RU2 and/or that the interference has stopped (or the interference has fallen below the first threshold, in the example described above). At Step S207, the STA1 14 stops transmitting data, and following a SIFS (Step S208), the STA1 14 transmits (Step S210) a new RU allocation (e.g., using RU1, RU2, and RU3) to the STA2 16. STA2 16 transmits feedback during Step S210, e.g., simultaneously or at least partially overlapping with the transmission of the new RU allocation, in some embodiments. Following another SIFS (Step S212), STA1 14 begins transmitting more data (e.g., CW8, CW9, and CW10, on RU1, RU2, and RU3, respectively). Once the data transmission is finished (Step S214), and following a SIFS (S216), the STA2 16 transmits feedback (e.g., acknowledgement signaling) on RU1, RU2, RU3, and RU4. In some embodiments, the feedback may only be transmitted on a subset of the available RUs.

Compared to the example of FIG. 10, the example of FIG. 11 illustrates the following:

STA1 14 may be configured to perform the encoding over one RU. That is, each CW may be contained in a single RU, rather than each CW being contained in multiple RUs.

STA2 16 is configured to send ACKs for every successfully decoded CW.

An alternative to this approach is to send ACKs/NACKs when the interference pattern or puncturing pattern changes. For example, if STA2 16 expects to receive 3 RUs in parallel, but only receives RU1 and RU3, STA2 16 is configured to send STA1 14 an ACK/NACK indicating this state. If, on the other hand, STA2 16 expects to receive only RU1 and RU3 but can also decode RU2, it notifies STA1 14 of this state with an ACK/NACK.

In some embodiments, when the each of the ACKs correspond to one CW, the NACKs may be configured to be implicit. For example, a CW that is not ACKed within a specific time after transmission is implicitly assumed to be not received and thus assumed lost.

As shown in the example of FIG. 11, STA1 14 may be configured to retransmit the earliest failed CW (e.g., CW7, in RU2).

For example, if the PPDU contains an aggregation of multiple MPDUs, it may be advantageous to attempt transmitting CWs as close to the chronological order as possible. Thus, an alternative to continually retransmitting CW7, as shown in FIG. 11, is to configure STA1 14 to re-allocate CW7 to another RU, and instead try another CW in the new slot. In the example of FIG. 11, in round 4 of the transmissions, STA1 14 may be configured to transmit CW4 or CW14 in RU2, and map CW7 to either RU1 or RU3.

In some embodiments, STA2 16 is configured to continuously monitor all RUs (e.g., all RUs within a configured bandwidth range or known range of RUs), and is configured to detect the disappearance of interference in RU2 (e.g., if RU2 channel quality improves over time). STA2 16 may be configured to feedback this information to STA1 14 indicating that the channel quality over RU2 has improved (e.g., the channel quality is detected to be at least a preconfigured minimum threshold). When the STA1 14 learns (e.g., receives an indication of), detects, and/or determines that the channel quality over RU2 has improved, it may be configured to re-allocate the RUs and send a PPDU indicating the new RU allocation and including the CWs not yet acknowledged and the CWs that have been explicitly NACKed.

In some embodiments, configurations may support multi-user OFDMA transmissions. For example, the STA1 14 may be configured to coordinate the downlink and serve multiple STA2s 16 in different RUs, and/or may coordinate the uplink by sending RU assignment indication(s), e.g., via the Basic Trigger Frame, to the STA2s 16, which may be configured to transmit their data in the assigned RU(s) accordingly.

In some embodiments, in the case of multi-user downlink transmissions, the STA1 14 may be configured to signal an RU that is not used for the data transmission but for NACK feedback from the receiving STA2s 16, similar to the single-user operation as described above. However, this RU may not be usable by the participating receiving STA2s 16, as NACK feedback may not be received by the STA1 14 correctly if multiple STA2s 16 send them at the same time. Therefore, the STA1 14 will poll the STA2s 16 for feedback regularly, e.g., by transmitting trigger frames on the signaled feedback RU, and thus may coordinate the transmissions (e.g., of feedback) among the multiple users/devices.

In some embodiments, configurations for multi-user OFDMA uplink may be supported, for example, where the STA1 14 may be configured to start with the trigger frame. One RU dedicated for the NACK feedback from the STA1 14 to the STA2s 16 may be kept idle, and the STA2s 16 may be configured to listen during their transmission(s) on this RU for NACKs addressed to them on this RU. In case the STA1 14 detects interference or reception errors of CWs, it may be configured to send a NACK on this RU, such that the addressed STA2s 16 can stop the transmission.

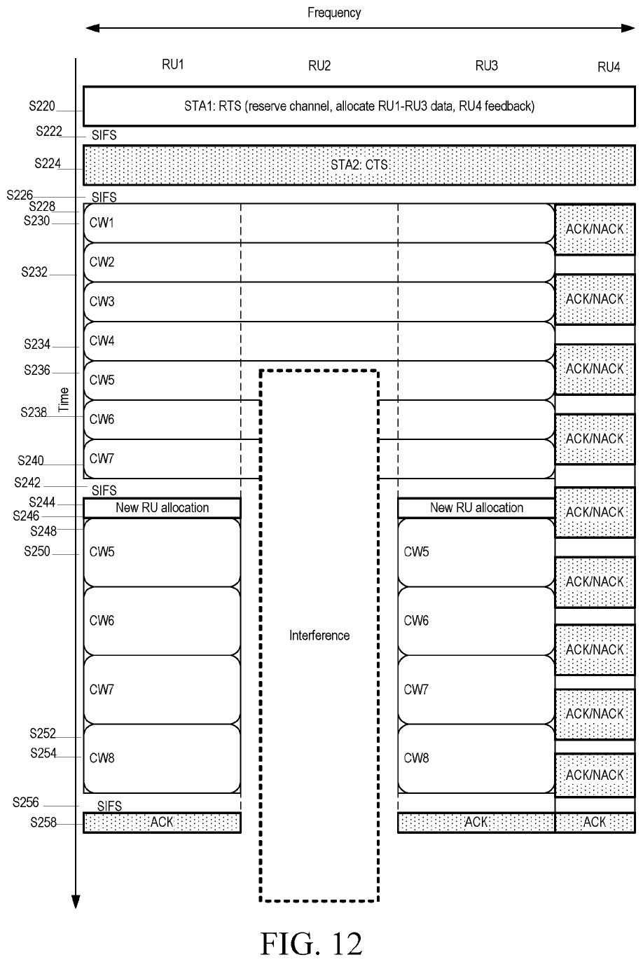

FIG. 12 is a signaling diagram which illustrates another example according to a third embodiment of the present disclosure. At Step S220, the STA1 14 transmits RTS signaling/information, which reserves channels, in this example, allocating RU1-RU3 for data and RU4 for feedback. Following a SIFS (Step S222), the STA2 16 transmits CTS signaling/information. Following another SIFS (Step S226), the STA1 14 begins transmitting (Step S228) codewords (CW1, CW2, etc.) over RU1, RU2, and RU3, as shown in the example of FIG. 12. At Step S230, STA2 16 transmits feedback on RU4 (e.g., either ACK or NACK signaling), which may be associated with one or more CW1, CW2, etc. Step S230, the transmission of the feedback on RU4, may occur simultaneously, or at least partially overlapping in time, with the transmission from STA1 14 of one or more codewords on RU1-RU3, as shown in FIG. 12. For example, in the example of FIG. 12, STA2 16 transmits ACK/NACK signaling at Step S232 and Step S234, containing feedback information corresponding to one or more of the codewords received by STA2 16. For example, as long as the codeword is transmitted within a margin of time that may include, e.g., sufficient processing time from the time that STA2 16 receives or fails to receive a codeword and the time needed for the STA2 16 to generate and begin transmitting the feedback, the feedback may include information for one or more of the codewords, accordingly. At Step S236, interference occurs in RU2, and codewords CW5, CW6, and CW7 may consequently be unreceivable and/or undecodable by STA2 16. At Step S238, STA2 16 transmits feedback on RU4 which indicates the failure to receive and/or decode and/or indicates the presence of the interference.

Referring still to FIG. 12, at Step S240, the STA1 14 stops transmission of the codewords on RU1-RU3, and, following a SIFS (Step S242), STA1 14 transmits a new RU allocation (Step S244) on RU1 and RU3. STA2 16 transmits an feedback (e.g., ACK/NACK) on RU4 (Step S246), which may be simultaneous with or at least partially overlapping in time with the transmission on RU1 and RU3 of the new RU allocation by STA1 14. At Step S248, STA1 14 begins transmitting the codewords again, but now on RU1 and RU3, in accordance with the new RU allocation, and at Step S250, STA2 16 transmits feedback (e.g., ACK/NACK signaling) on RU4, simultaneous with or at least partially overlapping in time with the transmission on RU1 and RU3 of the codewords, according to the pattern shown in FIG. 12, which continues until the final codeword (Step S252) is signaled on RU1/RU3 and the final feedback (Step S254) is signaled on RU4 by STA1 14 and STA2 16, respectively. Following another SIFS (Step 256), STA2 transmits acknowledgment signaling (Step S258) on RU1, RU3, and/or RU4. One or more of the feedback signals from the STA2 16 on RU4 may indicate that the interference in RU2 has not stopped (e.g., has not fallen below a preconfigured threshold level), and STA1 14 may be configured to use this information to continue with the “New RU Allocation” which only uses RU1 and RU3 for signaling to STA2 16.

In the example of FIG. 12, STA2 16 is configured to continually send ACKs/NACKs, separated by SIFS. This may enable preventing other STA2s 16 from attempting to access the wireless medium in RU4, e.g., so that they do not detect RU4 as idle. In some cases, at the time the ACK/NACK is prepared, no new CWs have been decoded with respect to a previous ACK/NACK report, in which case the information of the previous ACK/NACK report may be repeated, e.g., to increase reliability.

In addition to an RU quality indicator, the NACKS may also include information regarding and/or indicating the cause of the error (e.g., interference).

### ACK/NACK Procedure

Typically, in some Wi-Fi systems, ACKs may be sent on the same channel as the data it is acknowledging. There may be block-ACKs signaling reception of several MPDUs in an aggregated MPDU PPDU, for example. In some embodiments of the present disclosure, ACKs and NACKs may be configured differently as compared to some existing systems. For example, the STA2s 16 may be configured to report ACK/NACK for each CW, rather than for a full MPDU. In some embodiments, traditional MPDU granularity may be used, and a block-ACK may be used. Thus, embodiments of the present disclosure may be configured to support a variety of ACK/NACK procedures, including the following:
1. In some embodiments, each ACK may include a bitmap for all CWs received or not received in the transmission up until a point in time. For example, STA2 16 may be preconfigured with information regarding how many CWs it will receive in total, or may receive this information in a prior indication (e.g., from STA1 14). Since the ACK contains a bitmap, it may also act as a NACK. This ACK may be referred to as a “bitmap-ACK”.
   a. If a bitmap-ACK is sent by STA2 16, indicating that CWs are lost due to interference in one or many RUs, STA2 16 may be configured to expect a “New RU allocation” to be transmitted from STA1 14 within some known time, for example, an amount of time corresponding to a SIFS value, or a SIFS value plus a CW_length value. If a “New RU allocation” frame is not received by STA2 16 within the expected time, STA2 16 may be configured to assume the bitmap-ACK was lost and to transmit a new, updated bitmap-ACK (or retransmit the previous bitmap-ACK, depending on the configuration and/or whether any additional ACK information is ready to be reported). For example, the bitmap-ACK may be updated for the second transmission from the first transmission because new frames may have arrived.
   b. In some embodiments, the bitmap may be configured as a data structure such as a table indicating correctly received CWs.
   c. In some embodiments, the bitmap may be configured as a data structure such as a table indicating CWs received in error.
2. In some embodiments, ACKs are sent by STA2 16 on a per CW basis. If STA1 14 does not receive an ACK for a CW from STA2 16, it may be configured to assume the PPDU was lost and transmit a New RU allocation, where the RU(s) with the lost CW(s) is/are punctured. STA1 14 may be configured to retransmit the lost CWs to STA2 16. According to the illustration shown in FIG. 11, as an example, STA1 14 may be configured to determine when the interference has stopped (and/or fallen below some preconfigured threshold level), e.g., based on the CWs being sent on that RU being correctly decoded in STA2 16, or based on measurements by STA2 16. When that occurs, STA1 14 may be configured to send a New RU allocation frame to STA2 16 indicating the RU may be operational again.
3. In some embodiments, a bitmap-ACK or ACK/NACK reports may be sent only when there is a change in the interference pattern. For example, in some embodiments, STA2 16 may be configured to send an (additional) ACK (and/or NACK) for the full PPDU after the transmission is finished, and may omit one or more of the ACK/NACK reports for each CW (e.g., when there is no change in interference pattern, they may be omitted). In some embodiments, if the ACK for each CW through the PPDU is configured to be transmitted, then the full ACK after the PPDU may be discarded and/or omitted.

### Generalization of Usage of RU(s) Allocated for Feedback Reporting

In the example embodiments illustrated in FIG. 10, FIG. 11, and FIG. 12, the receiver of data (i.e., STA2 16) may be configured to inform the transmitter of data (i.e., STA1 14) of the presence and/or appearance and/or disappearance of interference in one or more RUs allocated for data. The RU(s) allocated for feedback reporting may also be used by STA2 16 to share further diverse information with STA1 14, which may not necessarily be restricted to information about interference (e.g., may include additional information beyond interference information).

For example, in some embodiments, at a given point in time, STA2 16 may be configured to indicate that the average channel quality (e.g., in terms of signal-to-noise-ratio, SNR, and/or other metrics) over the RUs allocated for data has improved (e.g., as compared to a previous value), and that STA1 14 may be enabled to encode the data with a more aggressive (e.g., a higher rate) modulation and coding scheme (MCS). STA1 14 may be configured to adapt the transmission accordingly, resulting in a higher data rate and/or lower latency. Similarly, STA2 16 may be configured to indicate that the average channel quality has deteriorated (e.g., as compared to a previous value), and that STA1 14 may be enabled to encode the data with a more robust MCS (e.g., a lower rate). STA1 14 may be configured to adapt the transmission accordingly, e.g., resulting in a lower data rate but with higher robustness of the data transmissions. In some embodiments, instead of reducing the data rate across all the RUs allocated for data, STA1 14 may instead be configured to puncture one or more out of the RUs that have the worst channel quality, even if the RUs could potentially be used (e.g., the quality of RU2 may be above a first minimum quality threshold, but below a second preferred quality threshold). Techniques for performing selective puncturing may be used (e.g., where puncturing may be performed even when it is not mandated) on some frequency resources without lowering the MCS, which may in certain instances provide higher data rates than lowering the MCS without performing any puncturing. For example, if STA2 16 determines that selective puncturing may help with an ongoing critical data transmission, it may be configured to suggest to STA1 14 (e.g., via a request signaling) to perform selective puncturing using, e.g., the RU(s) allocated for feedback reporting, and STA1 14 may be configured to adapt the transmission accordingly, e.g., such that the negative impact of the puncturing on data rate and/or latency may be limited.

In some embodiments, the RU(s) allocated for feedback reporting may be configured where there are multiple STAs transmitting critical data using the RUs allocated for data. For example, if STA2 16 and STA3 16 (i.e., a receiving device similar to STA2 16 which may be referred to as “STA3 16”) are transmitting critical data to STA1 14 (e.g., an AP, in some embodiments), then STA2 16 and STA3 16 may be configured use the RU(s) allocated for feedback reporting to signal their increased or decreased need of bandwidth resources to satisfy one or more latency/reliability constraints. In such a case, if STA1 14 is the device which is triggering the transmissions from STA2 16 and STA3 16 and assigning them RUs to use for data, STA1 14 may be configured to update its RU allocations and assign more bandwidth resources to one of the STA2s 16 and reduce the bandwidth allocation for the other STAs 16. Similar dynamic bandwidth allocation configurations may also be used if, for example, STA1 14 and STA2 16 are both sending critical data to each other using non-overlapping RUs, and while having a narrow RU reserved for feedback reporting. In some embodiments, for multi-user transmissions, a new RU allocation may be triggered not necessarily by interference issues, but by increased need, e.g., increased data rate needs, and the STA1 14 may be configured, e.g., to increase RU allocation for STA2 16 and decrease the allocation for STA3 16, accordingly.

### Example Signaling Descriptions

Embodiments of the present disclosure may support one or more signaling elements, such as:
An RU allocation frame; and
A NACK element.

In some embodiments, for a fast adaptive procedure, new frames may be configured, e.g., to cut down on excessive information in the preexisting frames.

### New RU Allocation Frame

In some embodiments, a new type of allocation frame may be used to signal to a STA (e.g., a STA1 14 and/or STA2 16) that the RUs used for operation should be changed (in some cases, indicating that the change should occur swiftly). Thus, information that may be contained in such a frame may include one or more of:
Time until switching;
An indication of whether a CW is contained withing a single RU, or across multiple RUs;
A per user-info field for OFDMA operation, including one or more of:
   A new type of RU allocation indication; and
   Any additional Tx parameter requirements, as appropriate.

Some pre-existing frames within the 802.11 standards that serve a similar purpose as this frame may be reused, in some embodiments, such as the Basic Trigger frame and Channel Switching frame. Both of these frames are already used in order to assign users to resources, and thus some embodiments may adapt these frames to a new purpose, as described herein.

### NACK Element

As described herein, there are a variety of information types and structures which the NACK element may include, e.g., depending on the usage of the sub band FD. For example, the NACK element may include one or more of:
Error information, e.g., on a bit-wise, codeword-wise, and/or MPDU-wise level;
RU granularity for the “per RU information”, e.g., an indication of whether the reporting is for every 2 MHz RU, or 20 MHz band, etc.
Per RU information, including, e.g.,:
   Interference information, such as:
      Single bit to inform of bad channel conditions; and/or
      SINR levels; and/or
   Other channel measurement and/or quality information.

Other preexisting frames in the 802.11 standard that may be reused for new purposes according to embodiments of the present disclosure include the Acknowledgement frame and the Block Acknowledgement frame.

### Additional Signaling Configurations

In some embodiments, signaling may be configured for cases where the interference may affect more than one device, for example, when operating under OFDMA or using a multi-AP (or multi-STA1 14) framework. In these cases, multiple devices may be configured to report using a NACK element signaling, and thus there may be a risk of collisions between the multiple devices' transmissions. Some embodiments may include configurations for avoiding such collisions, e.g., the STA1 14 may signal when initiating the sub band FD operation that feedback may be expected by more than one device. If that is the case, the feedback may be signaled (e.g., by STA1 14 and/or STA2 16) according to one or more of:
By randomly drawing a backoff number and doing channel access according to CSMA;
Using a smaller random RU within the RU used for control signaling, e.g., similar to an operation under UORA; and/or
In pre-configured time and/or frequency resources.

Embodiments where the receiving STA2 16 is not STR capable

In some embodiments, the transmitting STA1 14 may be capable of receiving the feedback report while still transmitting. In some embodiments, the receiving STA2 16 is STR capable, and therefore may continue receiving while the feedback report is being sent. In other embodiments, the receiving STA2 16 may not be STR-capable.

For example, the receiving STA2 16 may detect that some RUs are experiencing significant interference (e.g., above a threshold “acceptable” level of interference), indicating that the reception likely will fail, or at least partly fail. The receiving device STA2 16 may be configured to terminate the reception before the entire packet has been processed, and instead may switch to a transmission mode to send a feedback report. The feedback report, as described herein, may be similar whether the receiving STA2 16 is STR-capable or not. For the STA2 16 which is not STR-capable, no reception is possible at the same time as the feedback report is sent. Once the feedback report transmission is completed, the STA2 16 may switch back to receive mode to be prepared for a continuation of the transmission (e.g., with an updated RU allocation).

When the receiving STA2 16 is not STR capable and detects changed receiver conditions, e.g., due to an introduction of interference, it may be configured to send a feedback report. For example, if the receiving device STA2 16 determines that the experienced channel conditions have degraded so much (e.g., beyond a preconfigured threshold) that the reception with very high probability (e.g., probability above a preconfigured threshold) will fail, the receiving device STA2 16 may be configured to terminate the reception and send the feedback report. On the other hand, if the receiving device STA2 16 determines that the channel conditions are only slightly degraded (e.g., the quality has decreased but is still above a minimum preconfigured quality threshold) and/or that the reception very likely will be successful (e.g., the probability of a successful reception has decreased but is still above a minimum preconfigured probability threshold), the receiving device STA2 16 may be configured to continue the reception and may not interrupt the processing to send a feedback report. Instead, the receiving device STA2 16 may be configured to send the feedback report together with the ACK/NACK report such that updated interference information may be used (e.g., by STA1 14) for configuring a subsequent transmission.

In some embodiments, supporting simultaneous transmission and reception in a device (e.g., using SBFD mode of operation) may come at a considerable additional cost resulting from, for example, the need for improved Tx and/or Rx hardware to limit the generated self-interference, complex hardware and/or software algorithms to suppress the generated self-interference, etc. The additional cost and/or complexity may not be justifiable, in particular, for some types of STA2s 16, such as some types of non-AP STAs, some types of wireless devices, user equipment, mobile terminals, etc., and thus embodiments of the present disclosure may support configurations where a (transmitting) STA1 14 is STR-capable but one or more (receiving) STA2s 16 are not STR-capable. It is to be understood that embodiments of the present disclosure are not limited to only these types of devices, however, and in some cases, neither or both of the transmitting and receiving STAs/devices may be STR-capable.

In some embodiments, the configurations for feedback reporting as described herein may only be applied for certain classes of data, e.g., data which meets some criteria, such as “critical” data. For example, some data may be associated with low latency requirements, quality of service (QOS) requirements, a high priority index, etc., which may be used by STA1 14 and/or STA2 16 to determine whether to apply a configuration for simultaneous transmission and feedback reporting, as described herein, or whether to apply a legacy configuration. In other embodiments, the techniques described herein may be applied to all data signaling, without being restricted to or triggered by certain classes of data.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments.

Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ACK Acknowledgment
AP Access Point
CSD Criteria for Standard Development
CRC Cyclic Redundancy Check
CTS Clear To Send
CW Codeword
MLO Multi Link Operation
NACK Negative ACK
OFDMA Orthogonal Frequency Division Multiple Access
PAR Project Authorization Request
PPDU Physical Protocol Data Unit
RU Resource Unit
SIFS Short Inter-Frame Space
STA Station
TXOP Transmit Opportunity
UHR Ultra High Reliability
XR Extended Reality

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A method implemented in a first station (STA) configured to wirelessly communicate with a second STA in a wireless communication system, the first STA being configured with a full-duplex simultaneous transmission and reception (STR) configuration, the method comprising:
transmitting a first transmission of a first plurality of data units to the second STA according to a first resource configuration, the first resource configuration including a first mapping of the first plurality of data units to a first plurality of resource units (RUS) of a corresponding transmission channel;
receiving, during the first transmission, at least one first feedback report from the second STA the at least one first feedback report including feedback information for a receiver of the second STA and associated with the first transmission, the at least one first feedback report being received by the first STA using the full-duplex STR configuration, the full-duplex STR configuration allocating radio resources for the at least one first feedback report from the second STA to be transmitted concurrently with a data transmission from the first STA;
detecting a link failure associated with at least one failed data unit of the first plurality of data units based on the at least one first feedback report;
determining a second resource configuration for retransmitting the at least one failed data unit to the second STA, the second resource configuration including a second mapping of the at least one failed data unit to a second plurality of RUs of the corresponding transmission channel; and
transmitting a second transmission of the at least one failed data unit to the second STA according to the second resource configuration.

2. The method of claim 1, wherein the first STA is one of an access point (AP) and a non-AP STA; and
the second STA being one of an AP and a non-AP STA.

3. The method of claim 1, wherein the method further comprises receiving the at least one first feedback report from the second STA during the first transmission when the second STA is at least one of an STR-capable device and a full-duplex-capable device which is capable of transmitting the at least one first feedback report while continuing to receive the first transmission from the first STA.

4. The method of claim 1, wherein the method further comprises interrupting the first transmission based on the detection of the link failure.

5. The method of claim 1, wherein the full-duplex STR configuration comprises at least one of:
a frequency division duplexing (FDD) configuration;
an in-band full-duplex (IBFD) configuration; and
a subband full duplex (SBFD) configuration.

6. The method of claim 1, wherein the at least one first feedback report includes at least one of:
a bitmap indicating acknowledgment information for at least a subset of the first plurality of data units;
interference information associated with at least one RU of the first plurality of RUs;
measurement information associated with at least one RU of the first plurality of RUs;
an indication of a failure to decode the at least one failed data unit; and
an indication of a successful reception of at least one successful data unit of the first plurality of data units.

7. The method of claim 1, wherein the detecting of the reception failure includes detecting a failure to receive at least one expected feedback report from the second STA for at least one of the first plurality of data units.

8. The method of claim 1, wherein the determining of the second resource configuration includes puncturing a first RU of the first plurality of RUs based on the link failure being associated with at least one failed data unit transmitted on at least the first RU.

9. The method of claim 1, wherein the second transmission further includes a second plurality of data units, the second plurality of data units being transmitted according to the second resource configuration, the second mapping of the second resource configuration further mapping the second plurality of data units to the second plurality of RUs.

10. The method of claim 1, wherein the method further comprises at least one of:
transmitting, to the second STA a first indication of the first resource configuration;
transmitting, to the second STA a second indication of the second resource configuration; and
transmitting, to the second STA a third indication of the full-duplex STR configuration.

11.-21. (canceled)

22. A first station (STA) configured to wirelessly communicate with a second STA in a wireless communication system, the first STA being configured with a full-duplex simultaneous transmission and reception (STR) configuration, first STA comprising processing circuitry configured to:
cause a first transmission of a first plurality of data units to the second STA according to a first resource configuration, the first resource configuration including a first mapping of the first plurality of data units to a first plurality of resource units (RUs) of a corresponding transmission channel;
receive, during the first transmission, at least one first feedback report from the second STA the at least one first feedback report including feedback information for a receiver of the second STA and associated with the first transmission, the at least one first feedback report being received by the first STA using the full-duplex STR configuration, the full-duplex STR configuration allocating radio resources for the at least one first feedback report from the second STA to be transmitted concurrently with a data transmission from the first STA;
detect a link failure associated with at least one failed data unit of the first plurality of data units based on the at least one first feedback report;
determine a second resource configuration for retransmitting the at least one failed data unit to the second STA, the second resource configuration including a second mapping of the at least one failed data unit to a second plurality of RUs of the corresponding transmission channel; and
cause a second transmission of the at least one failed data unit to the second STA according to the second resource configuration.

23.-42. (canceled)

43. A method implemented in a first station (STA) configured to wirelessly communicate with a second STA in a wireless communication system, the first STA being configured with a full-duplex simultaneous transmission and reception (STR) configuration, the method comprising:
receiving a first transmission of a first plurality of data units from the second STA according to a first resource configuration, the first resource configuration including a first mapping of the first plurality of data units to a first plurality of resource units (RUs) of a corresponding transmission channel;
detecting a link failure for at least one failed data unit of the first plurality of data units;
transmitting to the second STA at least one first feedback report based on the link failure, the at least one first feedback report including feedback information for a receiver of the first STA and associated with the first transmission, the at least one first feedback report being transmitted by the first STA using the full-duplex STR configuration, the full-duplex STR configuration allocating radio resources for the at least one first feedback report from the first STA to be transmitted concurrently with a data transmission from the second STA; and
responsive to transmitting the at least one first feedback report, receiving a second transmission, from the second STA of the at least one failed data unit according to a second resource configuration, the second resource configuration including a second mapping of the at least one failed data unit to a second plurality of RUs of the corresponding transmission channel.

44. The method of claim 43, wherein the first STA is one of an access point (AP) and a non-AP STA; and
the second STA being one of an AP and a non-AP STA.

45. The method of claim 43, wherein the method further comprises transmitting the at least one first feedback report to the second STA without interrupting the receiving of the first transmission when the first STA is at least one of an STR-capable device and a full-duplex-capable device.

46. The method of claim 43, wherein the full-duplex STR configuration comprises at least one of:
a frequency division duplexing (FDD) configuration;
an in-band full-duplex (IBFD) configuration; and
a subband full duplex (SBFD) configuration.

47. The method of claim 43, wherein the at least one first feedback report includes at least one of:
a bitmap indicating acknowledgment information for at least a subset of the first plurality of data units;
interference information associated with at least one RU of the first plurality of RUs;
measurement information associated with at least one RU of the first plurality of RUs;
an indication of a failure to decode the at least one failed data unit; and
an indication of a successful reception of at least one successful data unit of the first plurality of data units.

48. The method of claim 43, wherein the second resource configuration includes a puncturing of a first RU of the first plurality of RUs based on at least one failed data unit being mapped to at least the first RU according to the first mapping.

49. The method of claim 43, wherein the second transmission further includes a second plurality of data units, the second plurality of data units being received according to the second resource configuration, the second mapping of the second resource configuration further mapping the second plurality of data units to the second plurality of RUs.

50. The method of claim 43, wherein the method further comprises at least one of:
receiving, from the second STA, a first indication of the first resource configuration;
receiving, from the second STA, a second indication of the second resource configuration; and
receiving, from the second STA, a third indication of the full-duplex STR configuration.

51.-61. (canceled)

62. A first station (STA) configured to wirelessly communicate with a second STA in a wireless communication system, the second STA being configured with a full-duplex simultaneous transmission and reception (STR) configuration, the first STA comprising processing circuitry configured to:
receive a first transmission of a first plurality of data units from the second STA according to a first resource configuration, the first resource configuration including a first mapping of the first plurality of data units to a first plurality of resource units (RUs) of a corresponding transmission channel;
detect a link failure for at least one failed data unit of the first plurality of data units;
cause transmission, to the second STA, of at least one first feedback report based on the link failure, the at least one first feedback report including feedback information for a receiver of the first STA and associated with the first transmission, the at least one first feedback report being transmitted by the first STA using the full-duplex STR configuration, the full-duplex STR configuration allocating radio resources for the at least one first feedback report from the first STA to be transmitted concurrently with a data transmission from the second STA; and
responsive to transmitting the at least one first feedback report, receive a second transmission, from the second STA, of the at least one failed data unit according to a second resource configuration, the second resource configuration including a second mapping of the at least one failed data unit to a second plurality of RUs of the corresponding transmission channel.

63.-80. (canceled)
